(19) United States
(12) Patent Application Publication
(10) Pub. No.: US 2026/0367772 A1
(43) Pub. Date: Nov. 19, 2026

(54) PRESENTING USER INTERFACES AND LIMITING PARTICIPATION IN A MULTI-USER COMMUNICATION SESSION

(71) Applicant: Apple Inc., Cupertino, CA (US)

(72) Inventors: Gabrielle ECANOW, Highland Park, IL (US); Alexander Burling RODRIGUEZ, Woodside, CA (US); Anish KANNAN, Sunnyvale, CA (US); Jacob A. PICCOLO, San Mateo, CA (US)

(21) Appl. No.: 19/642,325

(22) Filed: Apr. 8, 2026

Related U.S. Application Data
(60) Provisional application No. 63/808,525, filed on May 19, 2025.

(51) Int. Cl. G06F 3/04845; G06F 3/01; G06F 3/04815

(52) U.S. Cl. CPC G06F 3/04845; G06F 3/017; G06F 3/04815

(57) ABSTRACT

Some examples of the disclosure are directed to systems and methods for presenting user interfaces and limiting participation in a multi-user communication session. In some examples, a first electronic device is in a multi-user communication session with a second electronic device, wherein the first electronic device is collocated with the second electronic device in a physical environment. In some examples, the method includes presenting a first user interface corresponding to a shared user interface and a second user interface associated with the first user interface within a three-dimensional environment.

### CROSS-REFERENCE TO RELATED APPLICATIONS

This application claims the benefit of U.S. Provisional Application No. 63/808,525, filed May 19, 2025, the content of which is herein incorporated by reference in its entirety for all purposes.

### FIELD OF THE DISCLOSURE

This relates generally to systems and methods of presenting user interfaces and limiting participation in a multi-user communication session.

### BACKGROUND OF THE DISCLOSURE

Some computer graphical environments provide two-dimensional (2D) and/or three-dimensional (3D) environments where at least some objects displayed for a user’s viewing are virtual and generated by a computer. In some examples, the three-dimensional environments are presented by multiple devices communicating in a multi-user communication session. In some examples, an avatar (e.g., a representation) of each non-collocated user participating in the multi-user communication session (e.g., via the computing devices) is displayed in the three-dimensional environment of the multi-user communication session. In some examples, content can be shared in the three-dimensional environment for viewing and interaction by multiple users participating in the multi-user communication session.

### SUMMARY OF THE DISCLOSURE

Some examples of the disclosure are directed to systems and methods for presenting user interfaces and limiting participation in a multi-user communication session. In some examples, a method is performed at a first electronic device in communication with one or more displays and one or more input devices, wherein the first electronic device is collocated with a second electronic device in a physical environment. In some examples, while in a multi-user communication session with the second electronic device and while presenting, via the one or more displays, a first user interface corresponding to a shared user interface at a first location within a three-dimensional environment, the first electronic device detects, via the one or more input devices, an input directed to the first user interface. In some examples, in response to detecting the input directed to the first user interface, the first electronic device presents, via the one or more displays, a second user interface associated with the first user interface at a second location within the three-dimensional environment in accordance with the detected input. In some examples, while in a multi-user communication session with the second electronic device and while presenting, via the one or more displays, a first user interface corresponding to a shared user interface at a first location within a three-dimensional environment, the first electronic device detects an indication of generation of a second user interface associated with the first user interface. In some examples, in response to detecting the indication of the generation of the second user interface, in accordance with a determination that one or more criteria are satisfied, the first electronic device presents, via the one or more displays, a representation of the second user interface at a second location within the three-dimensional environment, different from the first location of the first user interface.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting a three-dimensional environment according to some examples of the disclosure.

FIGS. 2A-2C illustrate block diagrams of example architectures for electronic devices or systems according to some examples of the disclosure.

FIG. 3 illustrates an example of a spatial group in a multi-user communication session that includes a plurality of electronic devices according to some examples of the disclosure.

FIGS. 4A-4L illustrate examples of an electronic device presenting user interfaces and limiting participation in a multi-user communication session according to some examples of the disclosure.

FIG. 5 illustrates a flow diagram illustrating an example process for presenting a user interface associated with a shared user interface in a multi-user communication session according to some examples of the disclosure.

FIG. 6 illustrates a flow diagram illustrating an example process for presenting a representation of a user interface associated with a shared user interface in a multi-user communication session according to some examples of the disclosure.

### DETAILED DESCRIPTION

Some examples of the disclosure are directed to systems and methods for presenting user interfaces and limiting participation in a multi-user communication session. In some examples, a method is performed at a first electronic device in communication with one or more displays and one or more input devices, wherein the first electronic device is collocated with a second electronic device in a physical environment. In some examples, while in a multi-user communication session with the second electronic device and while presenting, via the one or more displays, a first user interface corresponding to a shared user interface at a first location within a three-dimensional environment, the first electronic device detects, via the one or more input devices, an input directed to the first user interface. In some examples, in response to detecting the input directed to the first user interface, the first electronic device presents, via the one or more displays, a second user interface associated with the first user interface at a second location within the three-dimensional environment in accordance with the detected input. In some examples, while in a multi-user communication session with the second electronic device and while presenting, via the one or more displays, a first user interface corresponding to a shared user interface at a first location within a three-dimensional environment, the first electronic device detects an indication of generation of a second user interface associated with the first user interface. In some examples, in response to detecting the indication of the generation of the second user interface, in accordance with a determination that one or more criteria are satisfied, the first electronic device presents, via the one or more displays, a representation of the second user interface at a second location within the three-dimensional environment, different from the first location of the first user interface.

In some examples, a spatial group or state in the multi-user communication session denotes a spatial arrangement or template that dictates locations of users and content that are located in or otherwise associated with the spatial group. In some examples, users in the same spatial group within the multi-user communication session experience spatial truth according to the spatial arrangement of the spatial group. In some examples, when the user of the first electronic device is in a first spatial group and the user of the second electronic device is in a second spatial group in the multi-user communication session, the users experience spatial truth that is localized to their respective spatial groups. In some examples, while the user of the first electronic device and the user of the second electronic device are grouped into separate spatial groups or states within the multi-user communication session, if the first electronic device and the second electronic device return to the same operating state, the user of the first electronic device and the user of the second electronic device are regrouped into the same spatial group within the multi-user communication session.

As used herein, a hybrid spatial group corresponds to a group or number of participants (e.g., users) in a multi-user communication session in which at least a subset of the participants is non-collocated in a physical environment. For example, as described via one or more examples in this disclosure, a hybrid spatial group includes at least two participants who are collocated in a first physical environment and at least one participant who is non-collocated with the at least two participants in the first physical environment (e.g., the at least one participant is located in a second physical environment, different from the first physical environment). In some examples, a hybrid spatial group in the multi-user communication session has a spatial arrangement that dictates locations of users and content that are located in the spatial group. In some examples, users in the same hybrid spatial group within the multi-user communication session experience spatial truth according to the spatial arrangement of the spatial group, as similarly discussed above.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user’s body (e.g., the user’s torso). Alternatively, in some examples, a body-locked object has a fixed distance from the user without the orientation of the content being referenced to any portion of the user’s body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user’s head. In some examples, a head-locked object moves within the three-dimensional environment as the user’s head moves (as a viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user’s body (e.g., the user’s torso) or the user’s head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user’s head). For example, the tilt-locked object is moved in the three-dimensional environment based on movement of the user’s head within a spherical space surrounding (e.g., centered at) the user’s head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

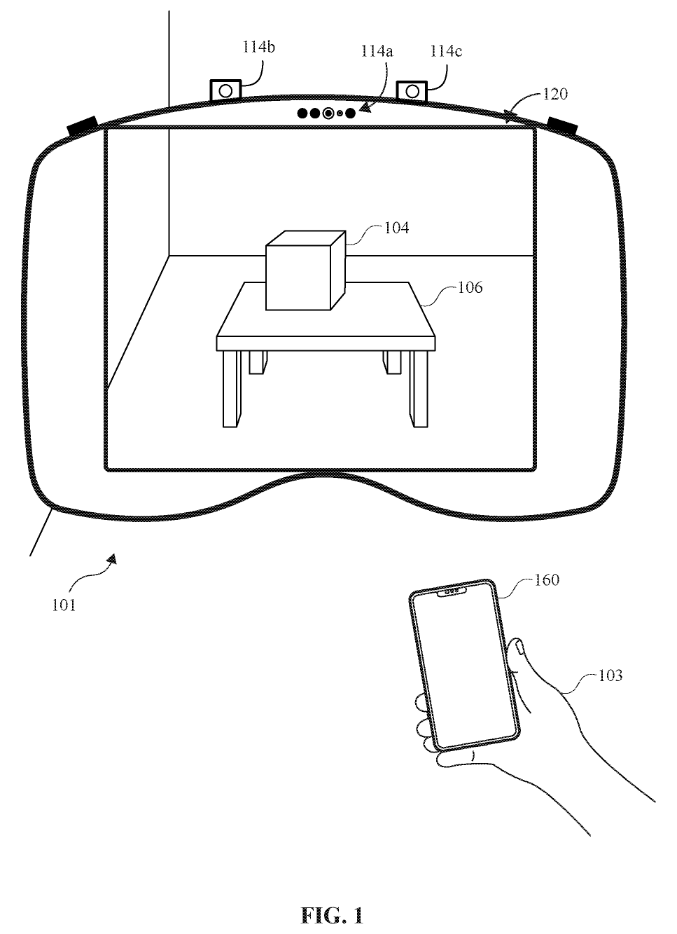

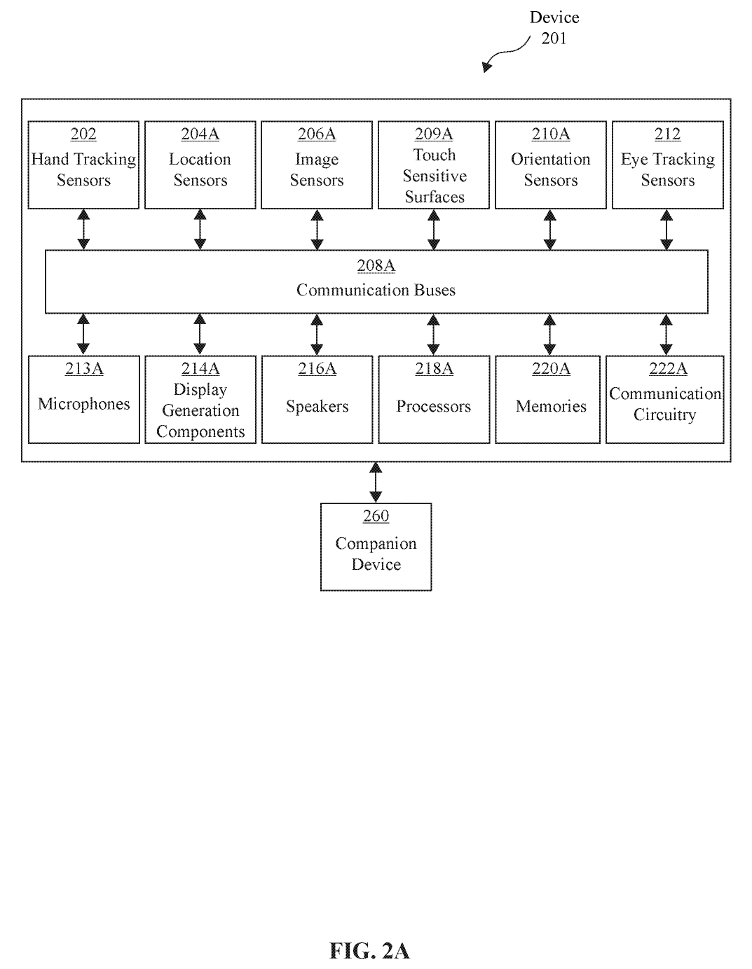

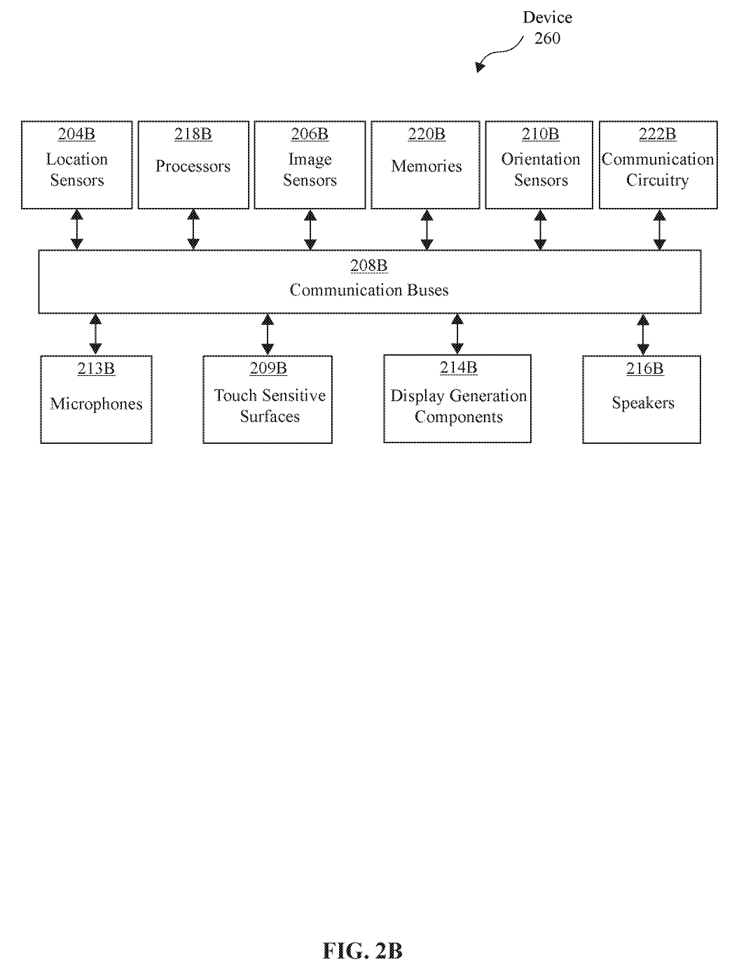

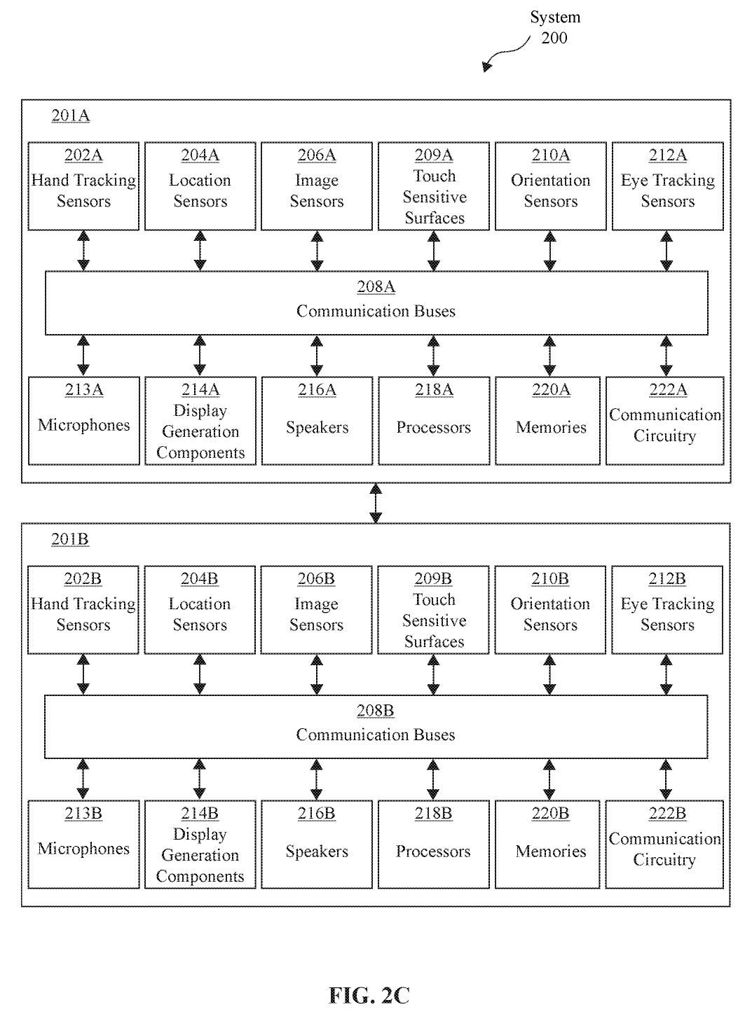

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user’s left and right eyes. In some examples, electronic device 101 also includes external image sensors 114b and 114c facing outwards from the user to detect and/or capture the physical environment of the electronic device 101 and/or movements of the user’s hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user’s eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user’s eyes. A viewpoint of a user determines what content is visible in the field of view, a viewpoint generally species a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user’s brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user’s field of view (e.g., the field of view of the user’s eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2C.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user’s gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2C illustrate block diagrams of example architectures for electronic devices or systems according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband ("UWB"), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user’s hands, and/or motions of one or more portions of the user’s hands with respect to the three-dimensional environment, relative to the one or more display generation components 214A, and/or relative to another defined coordinate system. The one or more eye tracking sensors 212 are configured to track the position and movement of a user’s gaze (e.g., a user’s attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user’s resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user’s eyes. The eye tracking cameras may be pointed towards a user’s eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

FIG. 2C illustrates a block diagram of an example architecture for a system 200 according to some examples of the disclosure. In some examples, system 200 includes multiple electronic devices. For example, in FIG. 2C, the system 200 includes a first electronic device 201A and a second electronic device 201B, wherein the first electronic device 201A and the second electronic device 201B are in communication with each other. In some examples, the first electronic device 201A and the second electronic device 201B correspond to and/or have one or more characteristics of the electronic device 201 described above with reference to FIG. 2A. In some examples, the first electronic device 201A and the second electronic device 201B correspond to electronic device 101 described above with reference to FIG. 1. For example, as shown in FIG. 2C, the first electronic device 201A optionally includes various sensors (e.g., the one or more hand tracking sensors 202A, the one or more location sensors 204A, the one or more image sensors 206A, the one or more touch-sensitive surfaces 209A, the one or more motion and/or orientation sensors 210A, the one or more eye tracking sensors 212A, the one or more microphones 213A or other audio sensors, the one or more body tracking sensors (e.g., torso and/or head tracking sensors), the one or more display generation components 214A, the one or more speakers 216A, the one or more processors 218A, the one or more memories 220A, and/or the communication circuitry 222A described above with reference to FIGS. 2A-2B. Similarly, in some examples, the second electronic device 201B optionally includes various sensors (e.g., one or more hand tracking sensors 202B, the one or more location sensors 204B, the one or more image sensors 206B, the one or more touch-sensitive surfaces 209B, the one or more motion and/or orientation sensors 210B, one or more eye tracking sensors 212B, the one or more microphones 213B or other audio sensors, one or more body tracking sensors (e.g., torso and/or head tracking sensors), the one or more display generation components 214B, one or more speakers 216B, the one or more processors 218B, the one or more memories 220B, and/or the communication circuitry 222B described above with reference to FIGS. 2A-2B. In some examples, the one or more hand tracking sensors 202B have one or more characteristics of the one or more hand tracking sensors 202A discussed above. In some examples, the one or more eye tracking sensors 212B have one or more characteristics of the one or more eye tracking sensors 212A. One or more communication buses 208A and 208B are optionally used for communication between the above-mentioned components of first electronic device 201A and second electronic device 201B, respectively. First electronic device 201A and second electronic device 201B optionally communicate via a wired or wireless connection (e.g., via the communication circuitry 222A, 222B) between the two electronic devices.

System 200 is not limited to the components and configuration of FIG. 2C, but can include fewer, other, or additional components and/or electronic devices in multiple configurations. In some examples, system 200 can be implemented in a single device. A person or persons using system 200, is optionally referred to herein as a user or users of the system and/or the devices or devices.

Attention is now directed towards exemplary concurrent displays of a three-dimensional environment on a first electronic device (e.g., corresponding to electronic device 201A) and a second electronic device (e.g., corresponding to electronic device 201B). As discussed below, the first electronic device may be in communication with the second electronic device in a multi-user communication session. In some examples, an avatar (e.g., a representation of) a user of the first electronic device may be displayed in the three-dimensional environment at the second electronic device, and an avatar of a user of the second electronic device may be displayed in the three-dimensional environment at the first electronic device. In some examples, the user of the first electronic device and the user of the second electronic device may be associated with a spatial group in the multi-user communication session. In some examples, interactions with content in the three-dimensional environment while the first electronic device and the second electronic device are in the multi-user communication session may cause the user of the first electronic device and the user of the second electronic device to become associated with different spatial groups in the multi-user communication session.

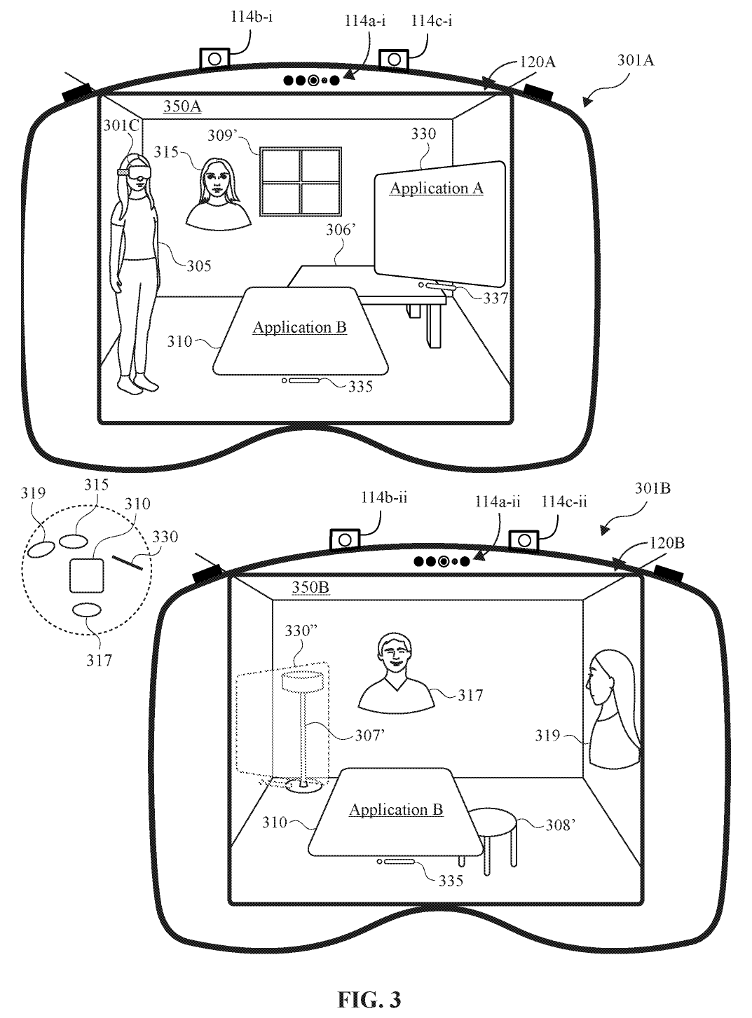

FIG. 3 illustrates an example of a spatial group in a multi-user communication session that includes a plurality of electronic devices according to some examples of the disclosure. In some examples, a first electronic device 301A may present a three-dimensional environment 350A, and a second electronic device 301B may present a three-dimensional environment 350B. The first electronic device 301A and the second electronic device 301B may be similar to electronic device 101 or 201A/201B, and/or may be a head mountable system/device and/or projection-based system/device (including a hologram-based system/device) configured to generate and/or present a three-dimensional environment, such as, for example, heads-up displays (HUDs), head mounted displays (HMDs), windows having integrated display capability, displays formed as lenses designed to be placed on a person’s eyes (e.g., similar to contact lenses), respectively. In the example of FIG. 3, a first user is optionally wearing the first electronic device 301A and a second user is optionally wearing the second electronic device 301B, such that the three-dimensional environment 350A/350B can be defined by X, Y and Z axes (or in other three-dimensional coordinate space coordinates) as viewed from a perspective of the electronic devices (e.g., a viewpoint associated with the electronic device 301A/301B, which may be a head-mounted display, for example).

As shown in FIG. 3, the first electronic device 301A may be in a first physical environment that includes a table 306 and a window 309. Thus, the three-dimensional environment 350A presented using the first electronic device 301A optionally includes captured portions of the physical environment surrounding the first electronic device 301A, such as a representation of the table 306’ and a representation of the window 309’. Similarly, the second electronic device 301B may be in a second physical environment, different from the first physical environment (e.g., separate in physical space from the first physical environment), that includes a floor lamp 307 and a coffee table 308. Thus, the three-dimensional environment 350B presented using the second electronic device 301B optionally includes captured portions of the physical environment surrounding the second electronic device 301B, such as a representation of the floor lamp 307’ and a representation of the coffee table 308’. Additionally, the three-dimensional environments 350A and 350B may include representations of the floor, ceiling, and walls of the room in which the first electronic device 301A and the second electronic device 301B are located, respectively.

In some examples, the first electronic device 301A and the second electronic device 301B are optionally in a multi-user communication session with third electronic device 301C. In some examples, a third user 305 is wearing the third electronic device 301C, which is optionally a head-mounted display, similar to the HMDs discussed above. In some examples, while the first electronic device 301A, the second electronic device 301B and the third electronic device 301C are in a multi-user communication session, the first electronic device 301A, the second electronic device 301B and the third electronic device 301C are configured to collaboratively present (e.g., via communication circuitry, such as communication circuitry 222A/222B in FIG. 2C) a shared three-dimensional environment (e.g., via their respective three-dimensional environments, such as three-dimensional environment 350A/350B) that includes one or more shared virtual objects (e.g., content such as images, video, audio and the like, representations of user interfaces of applications, etc.). As used herein, the term “shared three-dimensional environment” refers to a three-dimensional environment that is independently presented, displayed, and/or visible at a plurality of electronic devices via which content, applications, data, and the like may be shared and/or presented to users of the plurality of electronic devices.

In some examples, while the first electronic device 301A and the second electronic device 301B are in the multi-user communication session with the third electronic device 301C, a visual representation of a user of each electronic device is presented in the three-dimensional environment that is presented via the other electronic devices. In some examples, a type of visual representation that is presented at a respective electronic device within the multi-user communication session is based on whether the respective electronic device is collocated or non-collocated with the other electronic devices in the multi-user communication session, as described in more detail below.

In FIG. 3, the first electronic device 301A and the third electronic device 301C are collocated in the first physical environment. For example, the first electronic device 301A and the third electronic device 301C are both located in a same physical room that includes the table 306 and window 309. In some examples, the determination that the first electronic device 301A and the third electronic device 301C are collocated in the first physical environment is based on a distance between the first electronic device 301A and the third electronic device 301C. For example, in FIG. 3, the first electronic device 301A and the third electronic device 301C are collocated in the first physical environment because the first electronic device 301A is within a threshold distance (e.g., 0.1, 0.5, 1, 2, 3, 5, 10, 15, 20, etc. meters) of the third electronic device 301C. In some examples, the determination that the first electronic device 301A and the third electronic device 301C are collocated in the first physical environment is based on communication between the first electronic device 301A and the third electronic device 301C. For example, in FIG. 3, the first electronic device 301A and the third electronic device 301C are configured to communicate (e.g., wirelessly, such as via Bluetooth or other peer-to-peer communication networks, Wi-Fi, or a server (e.g., wireless communications terminal)) with each other. In some examples, the first electronic device 301A and the third electronic device 301C are connected to and/or are configured to communicate using a same wireless network in the first physical environment. In some examples, the determination that the first electronic device 301A and the third electronic device 301C are collocated in the first physical environment is based on a strength of a wireless signal transmitted between the first electronic device 301A and third electronic device 301C. For example, in FIG. 3, the first electronic device 301A and the third electronic device 301C are collocated in the first physical environment because a strength of a Bluetooth signal (or other wireless signal) transmitted between the first electronic device 301A and third electronic device 301C is greater than a threshold strength. In some examples, the determination that the first electronic device 301A and the third electronic device 301C are collocated in the first physical environment is based on visual detection of the first electronic device 301A and third electronic device 301C in the first physical environment. For example, as shown in FIG. 3, the third electronic device 301C is positioned in a field of view of the first electronic device 301A (e.g., because the third user 305 is standing in the field of view of the first electronic device 301A), which enables the first electronic device 301A to visually detect (e.g., identify or scan, such as via object detection or other image processing techniques) the third electronic device 301C (e.g., in one or more images captured by the first electronic device 301A, such as via external image sensors 114b-i and 114c-i). Similarly, in the example of FIG. 3, the first electronic device 301A is optionally positioned in a field of view of the third electronic device 301C (e.g., because the first user is standing in the field of view of the third electronic device 301C from a viewpoint of the third electronic device 301C), which enables the third electronic device 301C to visually detect the first electronic device 301A (e.g., in one or more images captured by the third electronic device 301C).

On the other hand, in FIG. 3, the second electronic device 301B is non-collocated with the first electronic device 301A or the third electronic device 301C. For example, as shown in FIG. 3 and as mentioned above, the second electronic device 301B is located (e.g., with the second user) in the second physical environment (e.g., including the floor lamp 307 and coffee table 308), which is different from the first physical environment in which the first electronic device 301A and the third electronic device 301C are both located. In some examples, while the second electronic device 301B is in the second physical environment, the second electronic device 301B is more than the threshold distance (e.g., discussed above) of the first electronic device 301A and the third electronic device 301A. Additionally or alternatively, in some examples, as shown in FIG. 3, the second electronic device 301B is not in the field of view of the first electronic device 301A and/or the third electronic device 301C.

As mentioned above, while electronic devices are communicatively linked in a multi-user communication session, users of the electronic devices may be visually represented within the shared three-dimensional environment based at least in part on the determination of whether the electronic devices are collocated or non-collocated with each other. In FIG. 3, because the first electronic device 301A and the third electronic device 301C are collocated in the first physical environment as discussed above, the users of the first electronic device 301A and third electronic device 301C are represented in the multi-user communication session via their physical personas (e.g., bodies) that are visible directly or in passthrough of the first physical environment (e.g., rather than via virtual representations generated and displayed by the electronic devices). For example, as shown in FIG. 3, the third user 305 is visible in the field of view of the first electronic device 301A (e.g., and the first user is visible in the field of view of the third electronic device 301C in the first physical environment) while the first electronic device 301A and the third electronic device 301C are in the multi-user communication session. In some examples, because the second electronic device 301B is non-collocated with the first electronic device 301A and the third electronic device 301C in the first physical environment, the second user of the second electronic device 301B is visually represented via an avatar 315 in the three-dimensional environment 350A. Similarly, at the second electronic device 301B, an avatar 317 corresponding to the first user of the first electronic device 301A and an avatar 319 corresponding to the third user 305 of the third electronic device 301C are displayed in the three-dimensional environment 350B (e.g., because the first electronic device 301A and the third electronic device 301C are non-collocated with the second electronic device 301B in the second physical environment as discussed above).

In some examples, the presentation of avatars 315/317/319 as part of a shared three-dimensional environment is optionally accompanied by an audio effect corresponding to a voice of the users of the electronic devices 301A/301B/301C. For example, the avatar 315 displayed in the three-dimensional environment 350A using the first electronic device 301A is optionally accompanied by an audio effect corresponding to the voice of the user of the second electronic device 301B. In some such examples, when the user of the second electronic device 301B speaks, the voice of the user may be detected by the second electronic device 301B (e.g., via the one or more microphones 213B in FIG. 2C) and transmitted to the first electronic device 301A (e.g., via the communication circuitry 222B/222A), such that the detected voice of the user of the second electronic device 301B may be presented as audio (e.g., using one or more speakers 216A) to the user of the first electronic device 301A in three-dimensional environment 350A. In some examples, the audio effect corresponding to the voice of the user of the second electronic device 301B may be spatialized (e.g., may be outputted as spatial audio), such that it appears to the user of the first electronic device 301A to emanate from the location of avatar 315 in the shared three-dimensional environment 350A (e.g., despite being outputted from the speakers of the first electronic device 360). Similarly, the avatars 317/319 displayed in the three-dimensional environment 350B using the second electronic device 301B are optionally accompanied by an audio effect corresponding to the voices of the users of the first electronic device 301A and the third electronic device 301C, respectively. For example, when the user of the first electronic device 301A speaks, the voice of the user may be detected by the first electronic device 301A (e.g., via the one or more microphones 213A) and transmitted to the second electronic device 301B (e.g., via the communication circuitry 222A/222B), such that the detected voice of the user of the first electronic device 301A may be presented as audio (e.g., using one or more speakers 216B) to the user of the second electronic device 301B in three-dimensional environment 350B. In some examples, the audio effect corresponding to the voices of the user of the first electronic device 301A and the user of the third electronic device 301C may be spatialized, such that they appear to the user of the second electronic device 301B to emanate from the location of avatar 317 and/or the location of the avatar 319 in the three-dimensional environment 350B (e.g., despite being outputted from the speakers of the second electronic device 301B).

In some examples, while in the multi-user communication session, the avatars 315/317/319 are displayed in the shared three-dimensional environment with respective orientations that correspond to and/or are based on orientations of the electronic devices 301A/301B/301C (and/or the users of electronic devices 301A/301B/301C) in the physical environments surrounding the electronic devices 301A/301B/301C. For example, as shown in FIG. 3, in the three-dimensional environment 350A, the avatar 315 is optionally facing toward the viewpoint of the user of the first electronic device 301A, and in the three-dimensional environment 350B, the avatar 317 is optionally facing toward the viewpoint of the user of the second electronic device 301B. As a particular user moves the electronic device (and/or themself) in the physical environment, the viewpoint of the user changes in accordance with the movement, which may thus also change an orientation of the user’s avatar in the three-dimensional environment. For example, with reference to FIG. 3, if the user of the first electronic device 301A were to look leftward in the three-dimensional environment 350A such that the first electronic device 301A is rotated (e.g., a corresponding amount) to the left (e.g., counterclockwise), the user of the second electronic device 301B would see the avatar 317 corresponding to the user of the first electronic device 301A rotate to the right (e.g., clockwise) relative to the viewpoint of the user of the second electronic device 301B in accordance with the movement of the first electronic device 301A.

Additionally, in some examples, while in the multi-user communication session, a field of view of the three-dimensional environments 350A/350B and/or a location of the viewpoint within the three-dimensional environments 350A/350B optionally changes in accordance with movement of the electronic devices 301A/301B/301C (e.g., by the users of the electronic devices 301A/301B/301C). For example, while in the communication session, when the first electronic device 301A is moved closer toward the representation of the table 306’ and/or the avatar 315 (e.g., because the user of the first electronic device 301A moved forward in the physical environment surrounding the first electronic device 301A), the field of view of the three-dimensional environment 350A would change accordingly, such that the representation of the table 306’, the representation of the window 309’ and the avatar 315 appear larger in the field of view. In some examples, each user may independently interact with the three-dimensional environment 350A/350B, such that changes in viewpoints within the three-dimensional environment 350A and/or interactions with virtual objects in the three-dimensional environment 350A by the first electronic device 301A optionally do not affect what is shown in the three-dimensional environment 350B at the second electronic device 301B, and vice versa.

In some examples, the avatars 315/317/319 are virtual representations (e.g., a full-body rendering) of the users of the electronic devices 301A/301B/301C. In some examples, a respective avatar is a representation of a portion or portions (e.g., a rendering of a head, face, head and torso, etc.) of the users of the electronic devices. In some examples, the avatars are user-personalized, user-selected, and/or user-created representations displayed in the three-dimensional environments 350A/350B that are representative of the users of the electronic devices 301A/301B/301C. It is understood that, while the avatars 315/317/319 illustrated in FIG. 3 correspond to bodily representations of the users of the electronic devices 301A/301B/301C, alternative avatars may be provided, such as those described above and/or having various dimensionality (e.g., three-dimensional or two-dimensional).

As used herein, relative to a first electronic device, a collocated user corresponds to a local user and a non-collocated user corresponds to a remote user. As similarly discussed above, the shared three-dimensional environment optionally includes avatars (e.g., avatars 315/317/319) corresponding to the remote users of the electronic devices that are non-collocated in the multi-user communication session. In some examples, the avatars corresponding to the remote users are generated and presented in the shared three-dimensional environment based on (e.g., using) skeletal data associated with the remote users. For example, the skeletal data is used to, at least partially, define one or more visual characteristics of the avatars (e.g., a size (e.g., height) and/or relative thickness of portions of the avatar, such as hands and/or limbs) in the three-dimensional environment. Additionally, the skeletal data is optionally used to track movement of the remote users, which, as discussed below, causes their corresponding avatars to be shifted and/or moved in the three-dimensional environment relative to the viewpoint of a first electronic device. In some examples, as discussed below, the skeletal data associated with local users may also be tracked and shared among the collocated electronic devices in the multi-user communication session to help facilitate presentation of and interaction with virtual objects (e.g., avatars and shared virtual content) in the three-dimensional environment.

As mentioned above, while the first electronic device 301A, the second electronic device 301B and the third electronic device 301C are in the multi-user communication session, their respective three-dimensional environments form and/or correspond to a shared three-dimensional environment that is presented using the electronic devices 301A/301B/301C. In some examples, content that is viewed by one user at one electronic device may be shared with another user at another electronic device in the multi-user communication session. In some such examples, the content may be experienced (e.g., viewed and/or interacted with) by multiple users (e.g., via their respective electronic devices) in the shared three-dimensional environment. For example, as shown in FIG. 3, the three-dimensional environments 350A/350B include a shared virtual object 310 (e.g., which is optionally a horizontally oriented board game associated with Application B) that is viewable by and interactive to the users of the electronic devices 301A/301B/301C. As shown in FIG. 3, the shared virtual object 310 is optionally displayed with a movement element 335 (e.g., a grabber affordance or handlebar or other user interface element) that is selectable to initiate movement of the shared virtual object 310 within the shared three-dimensional environment.

In some examples, the three-dimensional environments presented by the electronic devices include unshared content that is private to one or more users in the multi-user communication session. For example, in FIG. 3, the first electronic device 301A is displaying a private application window 330, which is optionally a virtual object that is not shared among the first electronic device 301A, the second electronic device 301B and the third electronic device 301C in the multi-user communication session. In some examples, the private application window 330 may be associated with a respective application (e.g., Application A) that is operating on the first electronic device 301A (e.g., such as a media player application, a web browsing application, a messaging application, etc.). Because the private application window 330 is not shared with the second electronic device 301B (e.g., or the third electronic device 301C), the second electronic device 301B optionally displays a representation of the private application window 330” in three-dimensional environment 350B. As shown in FIG. 3, in some examples, the representation of the private application window 330” may be a faded, occluded, discolored, and/or translucent representation of the private application window 330 that prevents the user of the second electronic device 301B (e.g., and the user of the third electronic device 301C) from viewing contents of the private application window 330.

As mentioned previously above, in some examples, the user of the first electronic device 301A, the user of the second electronic device 301B and the user of the third electronic device 301C are in and/or form a spatial group within the multi-user communication session. In some examples, the spatial group may be a baseline (e.g., a first or default) spatial group within the multi-user communication session. For example, when the user of the first electronic device 301A, the user of the second electronic device 301B and/or the user of the third electronic device 301C initially join the multi-user communication session, the user of the first electronic device 301A, the user of the second electronic device 301B, and the user of the third electronic device 301C are automatically (and initially) associated with (e.g., grouped into) the spatial group within the multi-user communication session. In some examples, while the users are in the spatial group as shown in FIG. 3, the user of the first electronic device 301A, the user of the second electronic device 301B and the user of the third electronic device 301C have a first spatial arrangement (e.g., arranged according to and/or defining a first spatial template) within the shared three-dimensional environment. For example, the user of the first electronic device 301A, the user of the second electronic device 301B, and the user of the third electronic device 301C, including objects that are shared and displayed in the shared three-dimensional environment, have spatial truth within the spatial group. In some examples, spatial truth requires a consistent spatial arrangement between users (or representations thereof) and shared virtual objects. For example, a distance between the viewpoint of the user of the first electronic device 301A and the avatar 315 corresponding to the user of the second electronic device 301B may be the same as a distance between the viewpoint of the user of the second electronic device 301B and the avatar 317 corresponding to the user of the first electronic device 301A. Similarly, in FIG. 3, a distance between the avatar 315 corresponding to the user of the second electronic device 301B and the physical location of the third electronic device 301C (e.g., including the third user 305) in the three-dimensional environment 350A from the viewpoint of the first electronic device 301A may be the same as a distance between the viewpoint of the user of the second electronic device 301B and the avatar 319 corresponding to the user of the third electronic device 301C in the three-dimensional environment 350B. As described herein, if the location of the viewpoint of the user of the first electronic device 301A moves, the avatar 317 corresponding to the user of the first electronic device 301A moves in the three-dimensional environment 350B in accordance with the movement of the location of the viewpoint of the user relative to the viewpoint of the user of the second electronic device 301B. As another example, if the user of the first electronic device 301A performs an interaction on the shared virtual object 310 (e.g., moves the virtual object 310 in the three-dimensional environment 350A), the second electronic device 301B (e.g., and the third electronic device 301C) alters or updates display of the shared virtual object 310 in the three-dimensional environment 350B in accordance with the interaction (e.g., moves the virtual object 310 by a corresponding (e.g., same) amount in the three-dimensional environment 350B). In the example of FIG. 3, the spatial group that is established among the first electronic device 301A, the second electronic device 301B, and the third electronic device 301C is a hybrid spatial group. For example, as defined herein, the multi-user communication session includes collocated and non-collocated users and electronic devices. Maintaining spatial truth among the viewpoints of the users in the multi-user communication session advantageously improves user interaction and experience of shared virtual objects and content. For example, it may be desirable to enable users who are collocated in a first physical environment and who are participating in a multi-user communication session with one or more users who are non-collocated in the first physical environment to coordinatively move and/or reposition virtual content that is shared and presented in a three-dimensional environment that is optionally viewable by and/or interactive to the collocated and non-collocated users in the multi-user communication session.

It is understood that, in some examples, fewer than and/or more than three electronic devices may be communicatively linked in a multi-user communication session. For example, in a situation in which two electronic devices are communicatively linked in a multi-user communication session, a first electronic device would present a single visual representation (e.g., a passthrough representation if collocated or a virtual representation (e.g., avatar) if non-collocated), rather than the two visual representations shown in FIG. 3, corresponding to the users of the other single electronic device. It should therefore be understood that the various processes and exemplary interactions described herein with reference to the first electronic device 301A, the second electronic device 301B, and the third electronic device 301C in the multi-user communication session illustrated in FIG. 3 optionally apply to situations in which fewer than or more than three electronic devices are communicatively linked in a multi-user communication session. It is also understood that, though illustrated in FIG. 3 as being such, a multi-user communication session need not include both collocated and non-collocated electronic devices (e.g., forming a hybrid spatial group). For example, a multi-user communication session can alternatively be established between solely collocated electronic devices (e.g., forming a local spatial group) or solely non-collocated electronic devices (e.g., forming a remote spatial group).

Attention is now directed towards interactions with one or more virtual objects that are displayed in a three-dimensional environment presented at an electronic device (e.g., corresponding to electronic devices 301A, 301B, and/or 301C of FIG. 3 and/or electronic devices 201A and/or 201B of FIG. 2C). For example, and as described, in more detail below, the electronic device presents the one or more virtual objects in a shared three-dimensional environment while in a multi-user communication session that includes collocated (and, optionally, non-collocated) users as described in more detail with reference to FIG. 3. In some examples, the one or more virtual objects include a shared virtual object (e.g., shared user interface or other shared virtual object described in more detail below and with reference to FIG. 3). In some examples, the electronic device enables the users in the multi-user communication session to experience synchronized interaction with the shared virtual object. In some examples, the electronic device applies spatial truth to the users and the shared virtual object. In some examples, the users and the shared virtual object having spatial truth have one or more characteristics of the user of the first electronic device 301A, the user of the second electronic device 301B, and the user of the third electronic device 301C, including the objects that are shared and displayed within the shared three-dimensional environment, having spatial truth as described above with reference to FIG. 3.

In some examples, while the electronic device is in the multi-user communication session and while presenting the shared virtual object, the electronic device detects one or more inputs corresponding to a user request to move the shared virtual object away from a docked location in the three-dimensional environment (e.g., a fixed position or optionally referred to as environment-locked/world-locked as described above) to a location in the three-dimensional environment that provides a better view (e.g., more accessible, more comfortable, or more aligned with the requesting user’s line of sight) than the view of the docked shared virtual object as described in more detail below. In some examples, in response to detecting the one or more inputs corresponding to the request to move the shared virtual object away from the docked position in the three-dimensional environment, the electronic device presents an instance (e.g., separate, detached clone) of the shared virtual object in the three-dimensional environment as described in more detail below. In some examples, presenting this instance of the shared virtual object includes breaking the requesting user’s spatial truth with the shared virtual object and/or other users in the multi-user communication session as described in more detail below. In some examples, presenting this instance of the shared virtual object includes limiting the requesting user’s participation in the multi-user communication session as described in more detail below.

The electronic devices, methods, and/or computer-readable storage mediums described below enhance the operability of the electronic device and make the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Reducing the number of inputs needed to perform an operation (such as by presenting a detached instance of the shared virtual object in response to input directed to the shared virtual object) enhances the operability of the device by reducing the number of inputs and time required to perform a particular operation, thereby reducing energy usage by the device. Providing improved feedback that a user of an electronic device is interacting with a private user interface and is thus placed in a limited participation state in a multi-user communication session with one or more other electronic devices (such as by presenting a representation of a detached instance of the shared virtual object in response to detecting an attention (e.g., gaze) of a first user of a first electronic device directed to a region of a three-dimensional environment that includes a representation of a second user of a second electronic device 101b interacting with the detached instance of the shared virtual object) enhances the operability of the device by reducing accidental and/or mistaken inputs, thereby reducing energy usage by the device.

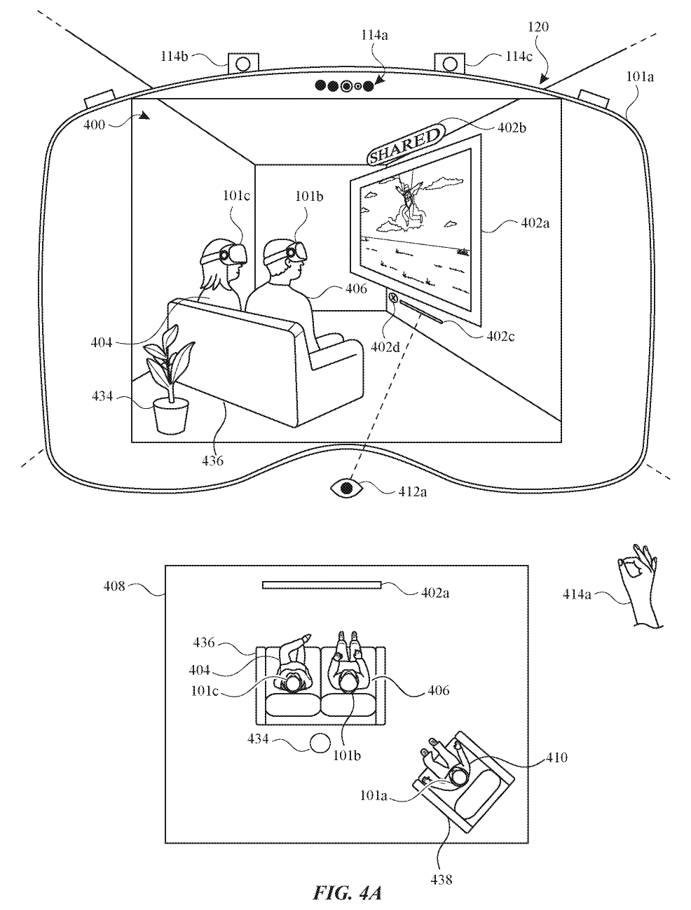

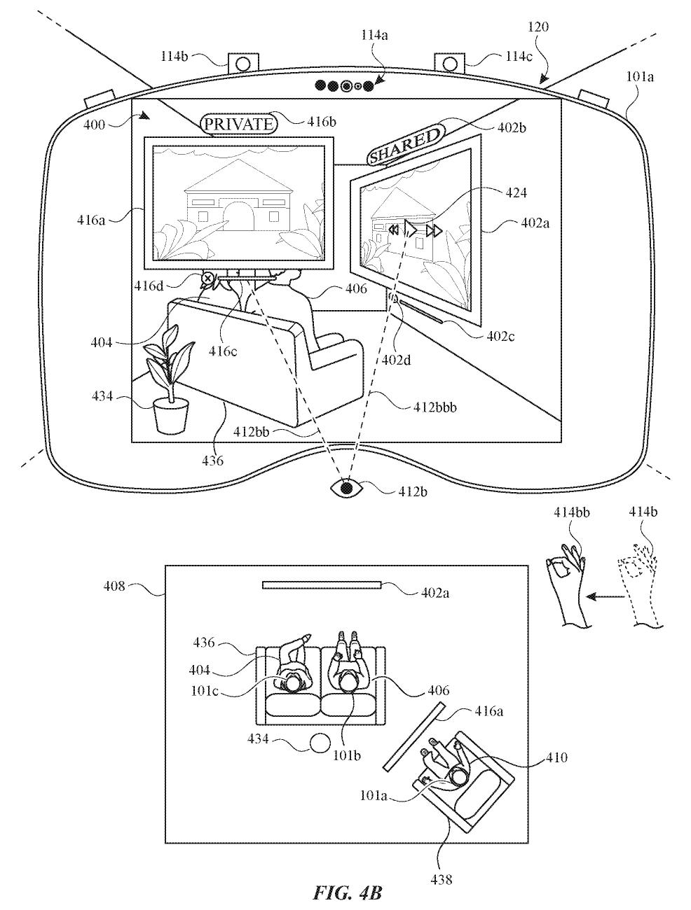

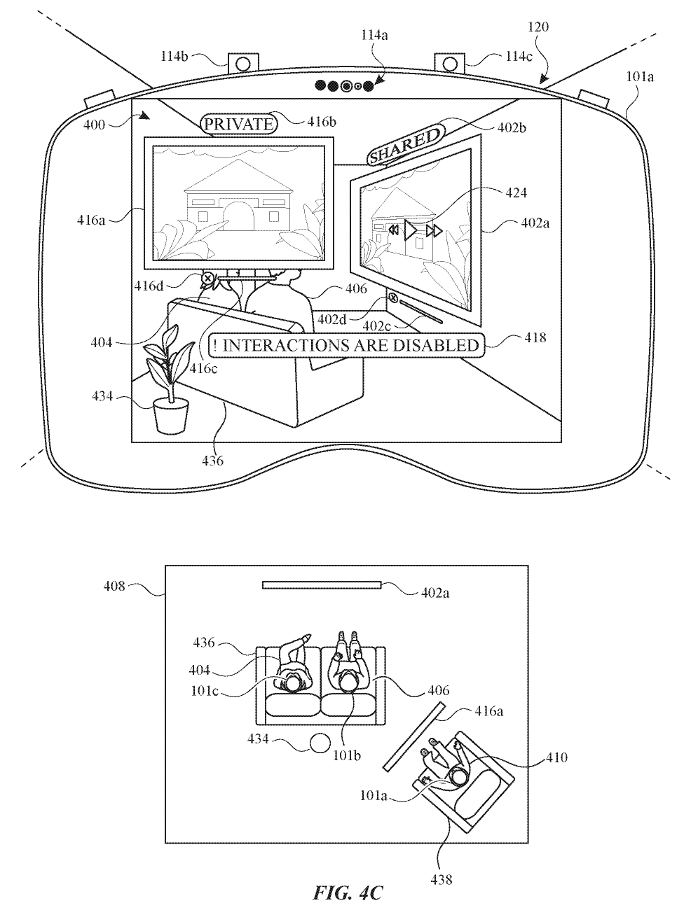

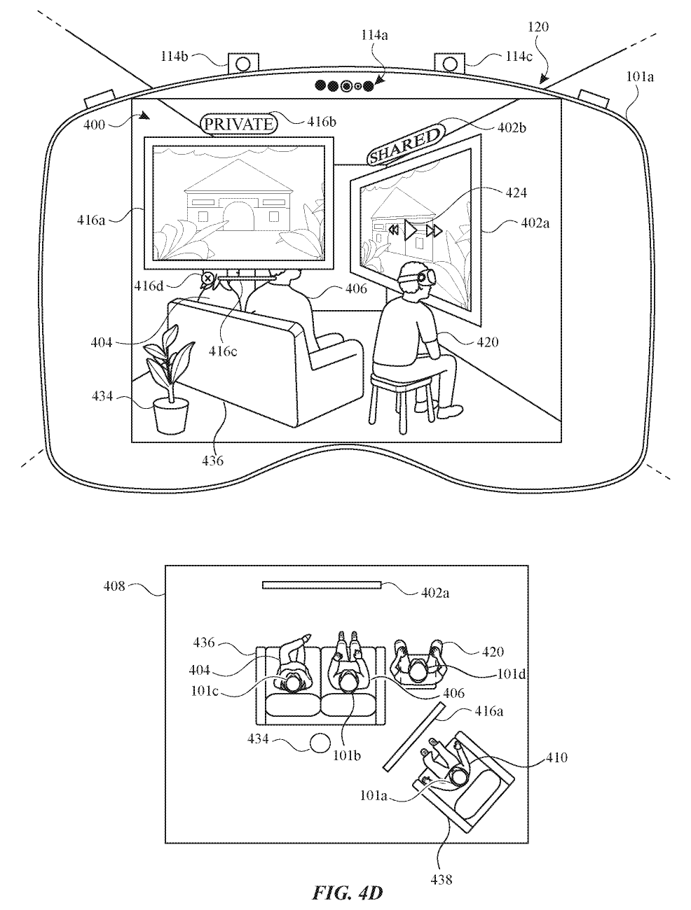

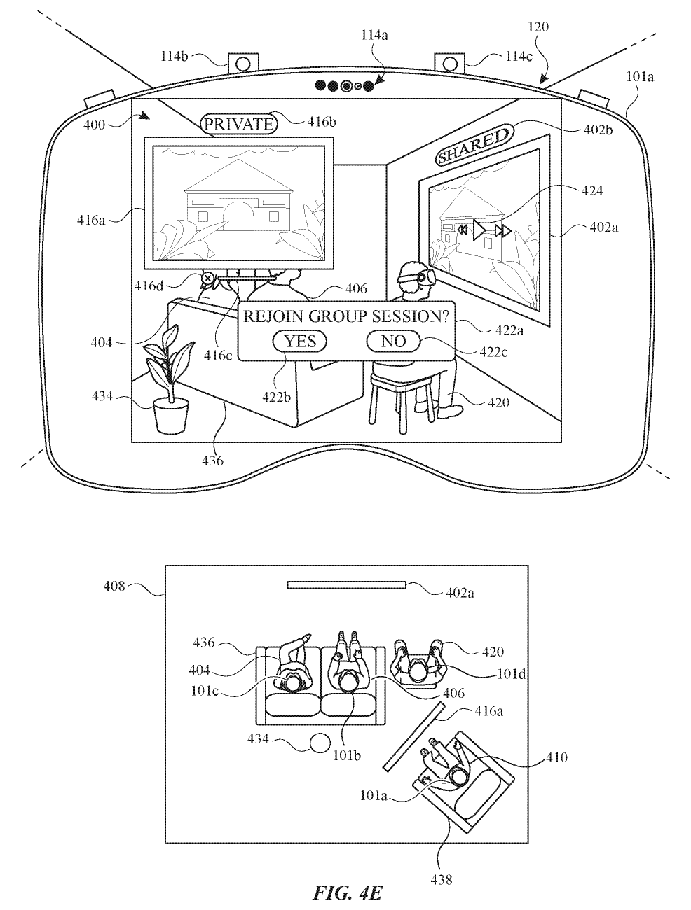

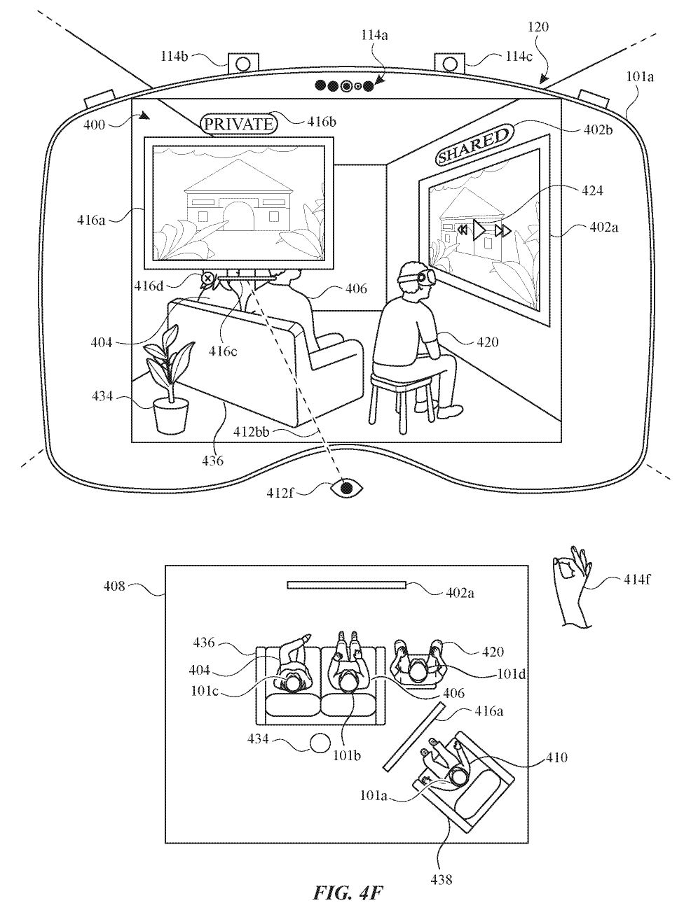

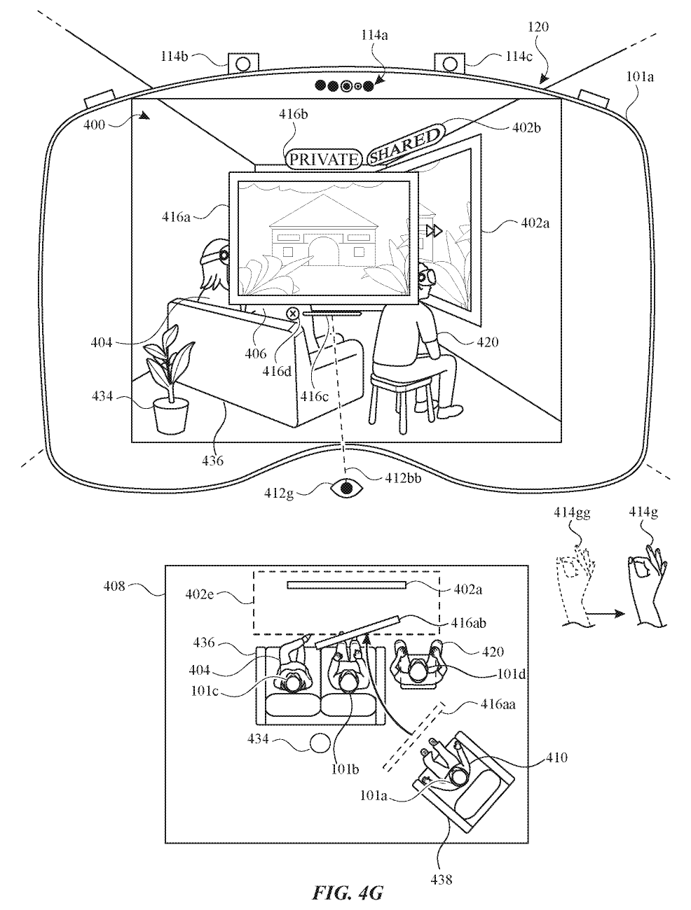

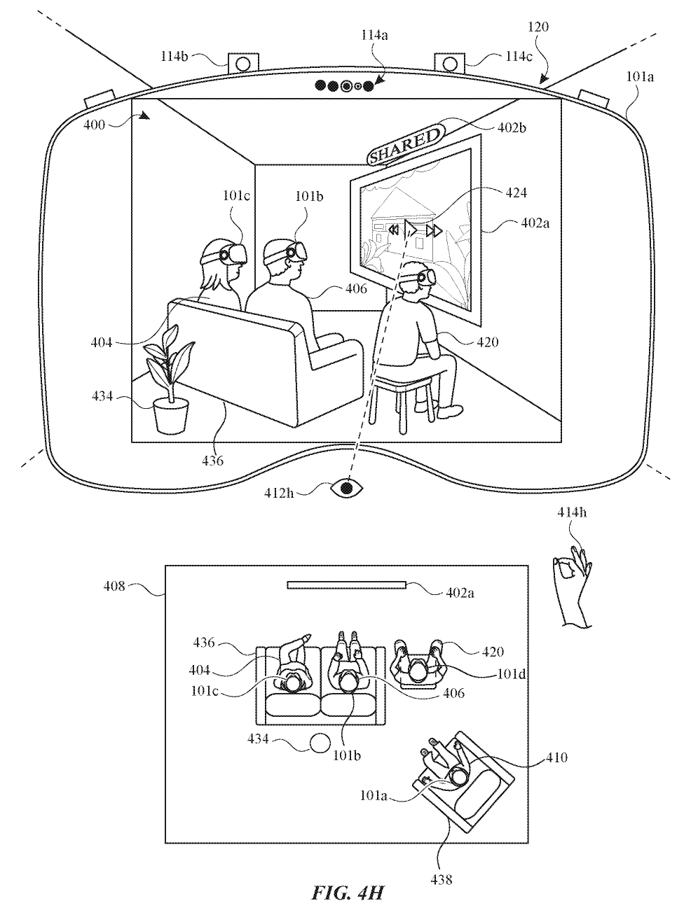

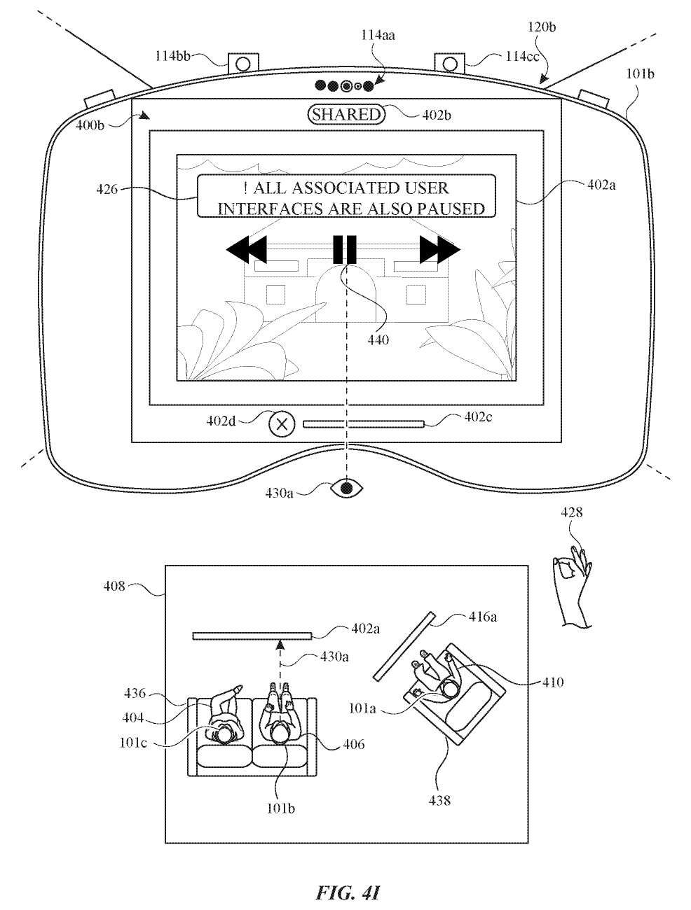

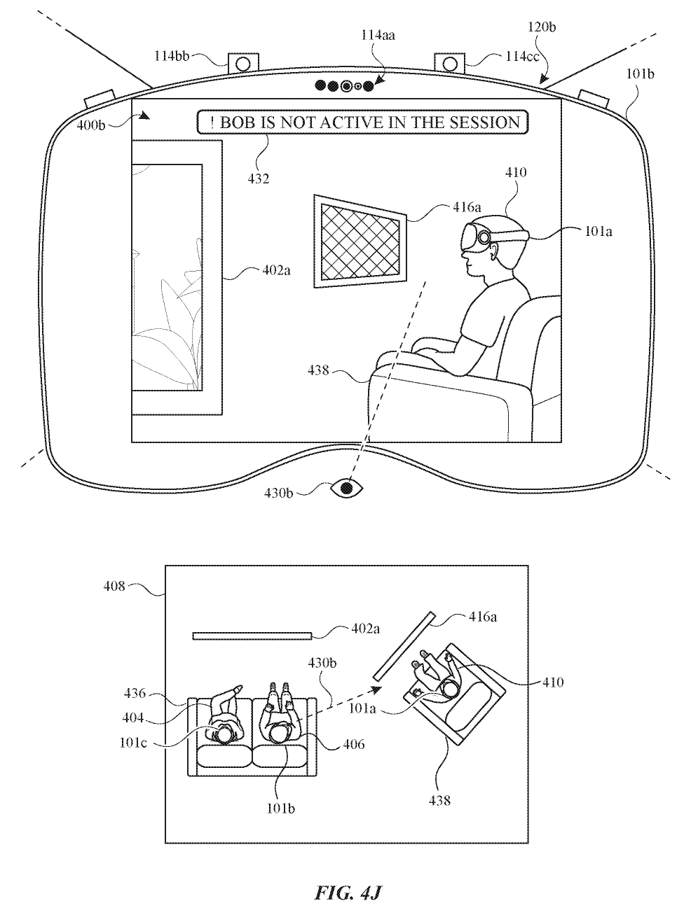

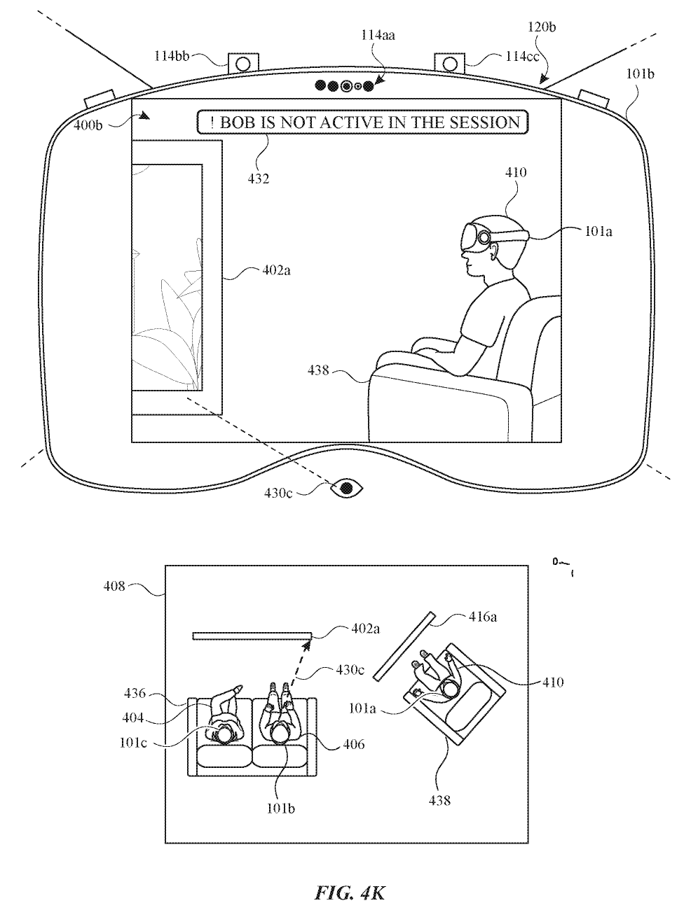

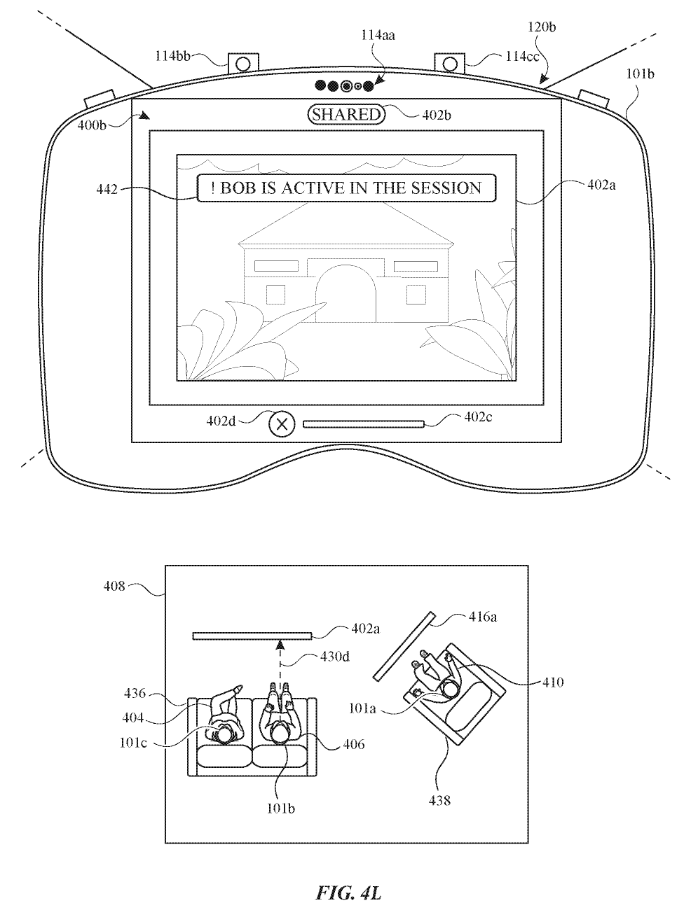

FIGS. 4A-4L illustrate examples of an electronic device presenting user interfaces and limiting participation in a multi-user communication session according to some examples of the disclosure. In some examples, and as shown in FIG. 4A including overhead view 408, while a first user 410 of a first electronic device 101a is in a multi-user communication session with a second user 406 of a second electronic device 101b and a third user 404 of a third electronic device 101c, three-dimensional environment 400 is presented using the first electronic device 101a (e.g., via display 120). In some examples, the first electronic device 101a, the second electronic device 101b, and the third electronic device 101c have one or more characteristics of (e.g., correspond to or are similar to) electronic devices 301A, 301B, and/or 301C of FIG. 3 and/or electronic devices 201A and/or 201B of FIG. 2C. In some examples, as shown in FIG. 4A including overhead view 408 in FIG. 4A, the first electronic device 101a is being used by (e.g., worn on a head of) the first user 410, the second electronic device 101b is being used by (e.g., worn on a head of) the second user 406, and the third electronic device 101c is being used by (e.g., worn on a head of) the third user 404.

In FIG. 4A, as indicated in the overhead view 408, the first user 410 of the first electronic device 101a, the second user 406 of the second electronic device 101b, and the third user 404 of the third electronic device 101c are collocated in a physical environment of the three-dimensional environment 400. For example, the first user 410 of the first electronic device 101a, the second user 406 of the second electronic device 101b, and the third user 404 of the third electronic device 101c are all located in a same room that includes real world objects, such as a houseplant 434, sofa 436 where the second user 406 and the third user 404 are seated, and recliner 438 where the first user 410 is seated. In some examples, determining that the first user 410 of the first electronic device 101a, the second user 406 of the second electronic device 101b, and the third user 404 of the third electronic device 101c are collocated in the physical environment of the three-dimensional environment 400 has one or more characteristics of determining that the first electronic device 301A and the third electronic device 301C of FIG. 3 are collocated in the physical environment of the three-dimensional environment 350A described above. For example, the determination that the first user 410 of the first electronic device 101a, the second user 406 of the second electronic device 101b, and the third user 404 of the third electronic device 101c are collocated in the physical environment of the three-dimensional environment 400 is based on a distance amongst the first electronic device 101a, the second electronic device 101b, and the third electronic device 101c in the physical environment of the three-dimensional environment 400, wireless communication strength amongst the first electronic device 101a, the second electronic device 101b, and the third electronic device 101c in the physical environment of the three-dimensional environment 400, and/or visual detection of the first electronic device 101a, the second electronic device 101b, and the third electronic device 101c in the physical environment of the three-dimensional environment 400.

In FIG. 4A, because the first electronic device 101a, the second electronic device 101b, and the third electronic device 101c are collocated in the physical environment of the three-dimensional environment 400 as discussed above, the first user 410 of the first electronic device 101a, the second user 406 of the second electronic device 101b, and the third user 404 of the third electronic device 101c are represented in the multi-user communication session via their physical personas (e.g., bodies) that are visible directly or in passthrough of the physical environment (e.g., rather than via virtual representations generated and displayed by the electronic devices). In some examples, representing the first user 410 of the first electronic device 101a, the second user 406 of the second electronic device 101b, and the third user 404 of the third electronic device 101c via their physical personas has one or more characteristics as representing the first electronic device 301A and third electronic device 301C via their physical personas in FIG. 3. For example, as shown in FIG. 4A, the second user 406 of the second electronic device 101b and the third user 404 of the third electronic device 101c are visible in the field of view of the first user 410 of the first electronic device 101a. In some examples, other real world objects in the physical environment of three-dimensional environment 400 are visible in the field of view of the first electronic device 101a, such as houseplant 434 and sofa 436, as shown in FIG. 4A. Additionally or alternatively, the first user 410 of the first electronic device 101a is not within the respective fields of view of the second user 406 of the second electronic device 101b and the third user 404 of the third electronic device 101c because, as shown in the overhead view 408, the second user 406 of the second electronic device 101b and the third user 404 of the third electronic device 101c are seated in the sofa 436 in front of the first user 410 of the first electronic device 101a (e.g., the first user 410 of the first electronic device 101a is behind the second user 406 of the second electronic device 101b and the third user 404 of the third electronic device 101c). In some examples, when the second electronic device 101b and/or the third electronic device 101c determine that the second user 406 of the second electronic device 101b and/or the third user 404 of the third electronic device 101c have moved, such as by rotating their heads in the direction of the first user 410 of the first electronic device 101a (e.g., as described in more detail below), the first user 410 of the first electronic device 101a becomes visible in the respective field of view of the second user 406 of the second electronic device 101b and/or the third user 404 of the third electronic device 101c.

As similarly described above with reference to FIG. 3, while the first user 410 of the first electronic device 101a, the second user 406 of the second electronic device 101b, and the third user 404 of the third electronic device 101c are collocated in the physical environment of three-dimensional environment 400, and while the first electronic device 101a, the second electronic device 101b, and the third electronic device 101c are in the multi-user communication session with each other, the first user 410 of the first electronic device 101a, the second user 406 of the second electronic device 101b, and the third user 404 of the third electronic device 101c may be in a spatial group within the multi-user communication session. In some examples, the spatial group has one or more characteristics of the spatial group discussed above with reference to FIG. 3. As similarly described above, while the first user 410 of the first electronic device 101a, the second user 406 of the second electronic device 101b, and the third user 404 of the third electronic device 101c are in the spatial group within the multi-user communication session, the users have a spatial arrangement in the shared three-dimensional environment (e.g., represented by the locations of and/or distance amongst the first user 410 of the first electronic device 101a, the second user 406 of the second electronic device 101b, and the third user 404 of the third electronic device 101c in the overhead view 408 in FIG. 4A) determined by the physical locations of the first user 410 of the first electronic device 101a, the second user 406 of the second electronic device 101b, and the third user 404 of the third electronic device 101c in the physical environment of the three-dimensional environment 400. In some examples, the first user 410 of the first electronic device 101a, the second user 406 of the second electronic device 101b, and the third user 404 of the third electronic device 101c experience spatial truth within the spatial group as dictated by the physical locations of and/or orientations of the first user 410 of the first electronic device 101a, the second user 406 of the second electronic device 101b, and the third user 404 of the third electronic device 101c, respectively.

In some examples, as similarly described above with reference to FIG. 3, while the first user 410 of the first electronic device 101a, the second user 406 of the second electronic device 101b, and the third user 404 of the third electronic device 101c are in the multi-user communication, a virtual object is able to be shared and/or interacted with by the first user 410 of the first electronic device 101a, the second user 406 of the second electronic device 101b, and the third user 404 of the third electronic device 101c in the three-dimensional environment 400. For example, as shown in FIG. 4A, the first electronic device 101a is displaying shared user interface 402a in the three-dimensional environment 400. In some examples, the shared user interface 402a has one or more characteristics of the shared virtual object or content described above with reference to FIG. 3. For example, the shared user interface 402a corresponds to a user interface of an application, such as a media content player user interface (e.g., audio/video content player, music player, or other media content player) of a media content streaming application running on the first electronic device 101a, the second electronic device 101b, and/or the third electronic device 101c. In some examples, the shared user interface 402a is shared among the first electronic device 101a, the second electronic device 101b, and the third electronic device 101c in the multi-user communication session, such that the content of the shared user interface 402a (e.g., the media content player user interface) is visible to and/or interactive to the first user 410, the second user 406, and the third user 404 via their respective electronic devices, as indicated by pill 402b displayed with the shared user interface 402a. In some examples, the pill 402b is selectable to initiate one or more sharing operations associated with the shared user interface 402a. For example, the pill 420b is selectable (e.g., via an air gesture, such as an air pinch or tap gesture) to share (e.g., and/or cease sharing) the content of the shared user interface 402a in the multi-user communication session. Additionally, in some examples, as shown in FIG. 4A, the shared user interface 402a is displayed with and/or includes grabber bar 402c, which is optionally selectable to initiate movement of the shared user interface 402a in the three-dimensional environment 400, and close button 402d, which is optionally selectable to close (e.g., cease to display) the shared user interface 402a.

In some examples, a respective electronic device (e.g., the first electronic device 101a, the second electronic device 101b, the third electronic device 101c, or other electronic device described herein) positions or places a shared virtual object (e.g., the shared user interface 402a) in a location within the three-dimensional environment (e.g., three-dimensional environment 400) based on a spatial arrangement or template that dictates locations of users and/or virtual objects within the multi-user communication session as described above, and in more detail, below. In some examples, the respective electronic device automatically positions the shared virtual object in a location within the three-dimensional environment automatically (e.g., without detecting input corresponding to a request to position the shared virtual object in the location in the three-dimensional environment). For example, in the overhead view 408 in FIG. 4A, the first electronic device 101a automatically positions the shared user interface 402a in a first location within the three-dimensional environment 400 that is viewable by and/or interactable to the first user 410 of the first electronic device 101a, the second user 406 of the second electronic device 101b, and the third user 404 of the third electronic device 101c. In some examples, the first electronic device 101a automatically positions the shared user interface 402a in the first location in accordance with a spatial arrangement or template (e.g., side-by-side template or theater viewing template, or other template described herein). For example, the first electronic device 101a determines that the second user 406 of the second electronic device 101b and the third user 404 of the third electronic device 101c are physically located next to each along a first line segment or shape (e.g., a curve), and/or that the first user 410 of the first electronic device 101a is physically located behind the second user 406 of the second electronic device 101b and the third user 404 of the third electronic device 101c along a second, (optionally curved) line segment as shown in overhead view 408 in FIG. 4A. In some examples, in accordance with this determination, the first electronic device 101a positions the shared user interface 402a (e.g., at a location and/or with an orientation in the three-dimensional environment 400) facing the first user 410 of the first electronic device 101a, the second user 406 of the second electronic device 101b, and the third user 404 of the third electronic device 101c (e.g., a majority of users). In some examples, because of this positioning of the shared user interface 402a, the second user 406 of the second electronic device 101b and the third user 404 of the third electronic device 101c have a different viewing angle of the shared user interface 402a than the first user 410 of the first electronic device 101a (e.g., due to the physical locations of the users in the physical environment as discussed above). In some examples, because of the physical location of the first user 410 of the first electronic device 101a, the first user 410 views the shared user interface 402a at an angle as shown in FIG. 4A (e.g., the front-facing surface of the shared user interface 402a is facing away from (e.g., toward the left of) the viewpoint of the first electronic device 101a in the three-dimensional environment 400). In some examples, the first user 410 requests and/or desires to view the shared user interface 402a from a better angle than the angle at which the first user 410 is currently viewing the shared user interface 402a. In some examples, in response to and/or in accordance with this request, the electronic device 101a enables/provides an experience in the multi-user communication session in which the first user 410 is provided a personal (e.g., private) view of the shared user interface 402a, while maintaining a shared group experience within the multi-user communication session as described in the following figures. Thus, in some examples, the first electronic device 101a maintains a shared context and automatically synchronizes the shared user interface 402a, as described in more detail in the figures that follow, such that the first user 410 is continually informed about the ongoing shared experience within the multi-user communication session.

In FIG. 4A, the first electronic device 101a detects user input corresponding to a request to move the shared user interface 402a. For example, the first electronic device 101a detects a sequence of one or more inputs that include an air pinch gesture 414a, optionally while attention 412a (e.g., gaze) of the first user 410 of the first electronic device 101a is directed to the grabber bar 402c of the shared user interface 402a. In response to detecting this sequence of one or more inputs, the first electronic device 101a selects the shared user interface 402a. In some examples, the first electronic device 101a detects that the sequence of one or more inputs includes movement of the air pinch gesture from a first location 414b to a second location 414bb in space, as shown in FIG. 4B. In response to detecting this sequence of one or more inputs, the first electronic device 101a optionally generates for display, via the display 120, a private user interface 416a associated with (e.g., linked to or dependent on) the shared user interface 402a, as shown in FIG. 4B. The first electronic device 101a further performs an action to undock (e.g., release or separate) the private user interface 416a from the fixed position in the three-dimensional environment 400 that is still occupied by the shared user interface 402a, and move the private user interface 416a in accordance with the movement of the air pinch gesture, as shown in FIG. 4B. For example, the first electronic device 101a moves the private user interface 416a from a first location within the three-dimensional environment 400 (e.g., corresponding to the respective location of the shared user interface 402a) to a second location within the three-dimensional environment 400, while attention 412b (e.g., gaze) of the user of the electronic device 101 is directed to the grabber bar 416c of the private user interface 416a, as shown in FIG. 4B. In some examples, at this second location, the first user 410 of the first electronic device 101a has a better view (e.g., more accessible, more comfortable, or more aligned with the requesting user’s line of sight) of the content being displayed than the view of the content provided via the shared user interface 402a, as shown in FIG. 4B including overhead view 408.

In some examples, moving the private user interface 416a does not cause the shared user interface 402a to move. In some examples, the first electronic device 101a concurrently displays the private user interface 416a and the shared user interface 402a having a spatial arrangement (e.g., specific to the first user 410 of the first electronic device) that enables both user interfaces to remain visible within the field of view of the first user 410 of the first electronic device 101a. In some examples, the first electronic device 101a imposes one or more spatial constraints to the movement of the private user interface 416a to ensure that the private user interface 416a and the shared user interface 402a both remain visible within the field of view of the first user 410 of the first electronic device 101a. In some examples, the one or more spatial constraints include a requirement that the private user interface 416a be located within a predetermined distance (e.g., 0.5, 1, 2, 3, 5, 10, 15, 20, or 30 meters) from the shared user interface 402a in order for the one or more spatial constraints to be satisfied. In some examples, by imposing the one or more spatial constraints, the first user 410 of the first electronic device 101a is reminded or aware of the on-going multi-user communication session with the second user 406 of the second electronic device 101b and the third user 404 of the third electronic device 101c as will be described in more detail in the figures that follow. Additionally or alternatively, in response to detecting the sequence of one or more inputs described above (e.g., corresponding to a request to undock and move the shared user interface 402a, thus creating the private user interface 416a), the first electronic device 101a automatically (e.g., without detecting further input) snaps or displays the private user interface 416a at the second location as shown in FIG. 4B.

In some examples, the private user interface 416a has one or more characteristics of the private application window 330 in FIG. 3. In some examples, the private user interface 416a has one or more characteristics of the shared user interface 402a. For example, in FIG. 4B, the private user interface 416a includes the following user interface elements: a grabber bar 416c that, when selected, causes the first electronic device 101a to initiate movement of the private user interface 416a in the three-dimensional environment 400; a close button 416d that, when selected, causes the electronic device 101 to close (e.g., cease to display) the private user interface 416a; and a pill 416b indicating that this user interface is private to the first user 410 of the first electronic device 101a as described above, and in more detail, below. In some examples, interactions with the private user interface 416a are limited as described above with reference to private application window 330 in FIG. 3. For example, the private user interface 416a is a user interface that is not resizable in response to user input. In some examples, the private user interface 416a is a virtual instance or cloned instance of the shared user interface 402a. In some examples, the private user interface 416a is linked to or dependent on the shared user interface 402a, such that the display of the content within the private user interface 416a is synchronized with that of the shared user interface 402a. For example, the content of the private user interface 416a is updated in real-time with the respective content of the shared user interface 402a. For example, stopping (e.g., pausing) or playing the media content item of the shared user interface 402a causes the respective media content item of the private user interface 416a to stop (e.g., pause) or play. In some examples, the contents of the private user interface 416a are not visible to the second user 406 of the second electronic device 101b and the third user 404 of the third electronic device 101c as will be described in more detail in the figures that follow. In some examples, the first electronic device 101a provides an indication to the second electronic device 101b and the third electronic device 101c that the first user 410 of the first electronic device 101a is interacting with the private user interface 416a, as will be described in more detail in the figures that follow. In some examples, the first electronic device 101a provides a second indication to the second electronic device 101b and the third electronic device 101c that the private user interface 416a has been generated. In some examples, in response to receiving this second indication, the second electronic device 101b and the third electronic device 101c determine that the first user 410 of the first electronic device 101a is an inactive participant within the multi-user communication session, as will be described in more detail below.

In some examples, while the first electronic device 101a displays the private user interface 416a, the first user 410 of the first electronic device 101a is placed in a limited participation state in the multi-user communication session. For example, the first user 410 of the first electronic device 101a becomes an inactive participant within the multi-user communication session (e.g., while the private user interface 416a is displayed) and thus one or more interactions with the shared user interface 402a are limited. For example, and as shown in FIG. 4B, the first electronic device 101a detects one or more selection inputs that include an air pinch gesture (e.g., similar to the air pinch gesture 414a in FIG. 4A), while attention 412b (e.g., gaze) of the first user 410 of the first electronic device 101a is directed to a play option 424 of the shared user interface 402a that, when selected causes the first electronic device 101a to play the media content item. In response to detecting these one or more selection inputs, as shown in FIG. 4C, the first electronic device 101a optionally presents, via the display 120, a notification 418 that interactions with the shared user interface 402a are disabled. In some examples, the first user 410 of the first electronic device 101a is also prevented from triggering the actions associated with the grabber bar 402c and the close button 402d while in this limited participation state (e.g., caused by the presenting of the private user interface 416a). In some examples, the first electronic device 101a displays the grabber bar 402c and the close button 402d with a visual appearance (e.g., grey coloring) indicative of a disabled interaction state. In some examples, interactions with the shared user interface 402a including interactions with the grabber bar 402c and the close button 402d are/remain afforded to the second user 406 of the second electronic device 101b and the third user of the third electronic device 101c.

In some examples, while the first electronic device 101a displays the private user interface 416a, the private user interface 416a is displayed in a limited mode (e.g., view-only mode). For example, the private user interface 416a does not include selectable options to change the media content item associated with the private user interface 416a (e.g., play option, pause option, fast-forward option, skip-back/rewind option, and/or any other options to change presentation/playback of the media content item). In some examples, the first electronic device 101a displays these options as disabled (e.g., with a visual appearance indicative of a disabled interaction state as described above). For example, displaying the private user interface 416a includes a pause option with a disabled interaction state. In some examples, while displaying the private user interface 416a including the pause option with the disabled interaction state, the first electronic device 101a detects one or more selection inputs that include an air pinch gesture (e.g., similar to the air pinch gesture 414a in FIG. 4A), while attention 412b (e.g., gaze) of the first user 410 of the first electronic device 101a is directed to the pause option. In response to detecting the one or more selection inputs, the first electronic device 101a maintains the display of the private user interface 416a (e.g., in the same state prior to detecting the one or more selection inputs) and optionally presents, via the display 120, a notification having one or more similar characteristics of notification 418 described above. In some examples, and as described above and/or below, although the option to pause is disabled, interactions with the grabber bar 416c and the close button 416d are enabled.

In some examples, when one or more new users join the multi-user communication session, the respective electronic device (e.g., the first electronic device 101a, the second electronic device 101b, or the third electronic device 101c) integrates the one or more new users into the spatial arrangement or template that dictates locations of users and virtual objects or content within the multi-user communication session as described above, and in more detail, in the following figures. In some examples, because the first user 410 of the first electronic device 101a is currently an inactive participant as described above while the private user interface 416a is presented in the three-dimensional environment 400, the location of the first user 410 of the first electronic device 101a is not considered when updating the presentation of the shared user interface 402a. For example, while the shared user interface 402a is located in the first location in accordance with the spatial arrangement or template described above with reference to FIG. 4A (e.g., side-by-side template), the first electronic device 101a detects a new collocated user in the physical environment of the three-dimensional environment 400 has joined the multi-user communication session, such as a fourth user 420 of a fourth electronic device 101d, as shown in FIG. 4D including overhead view 408. In some examples, the fourth electronic device 101d has one or more characteristics of the first electronic device 101a, the second electronic device 101b, and/or the third electronic device 101c. In some examples, in response to and/or while detecting the fourth user 420 of the fourth electronic device 101d has joined the multi-user communication session, the first electronic device 101a receives instructions or other data from the second electronic device 101b, the third electronic device 101c, and/or the fourth electronic device 101d to update a position of the shared user interface 402a in accordance with an updated spatial arrangement that includes the fourth user 420 of the fourth electronic device 101d joining the multi-user communication session. In some examples, because the first user 410 of the first electronic device 101a is an inactive participant in the multi-user communication session, the first electronic device 101 forgoes (e.g., locally or independently) determining or calculating the updated position of the shared user interface 402a. For example, the first electronic device 101a determines that the fourth user 420 of the fourth electronic device 101d is physically located next to the second user 406 of the second electronic device 101b along the first line segment as shown in overhead view 408 in FIG. 4D, and in accordance with this determination, the first electronic device 101a repositions the shared user interface 402a (e.g., at an updated location and/or with an updated orientation) facing the fourth user 420 of the fourth electronic device 101d, the second user 406 of the second electronic device 101b, and the third user 404 of the third electronic device 101c (e.g., irrespective of the first user 410 of the first electronic device). For example, the first electronic device 101a moves the shared user interface 402a to a second location as shown in the overhead view 408, different from the first location as shown in the overhead view 408 in FIG. 4D.

In some examples, as shown in FIG. 4E, after moving the shared user interface 402a to the second location in the three-dimensional environment 400, the first electronic device 101a displays, via the display 120, a notification 422a to rejoin the multi-user communication session that includes a first option 422b that, when selected, causes the electronic device 101a to become an active participant in the multi-user communication session and a second option 422c that, when selected, causes the first electronic device 101a to maintain the inactive participant state. In some examples, in response to detecting selection of option 422b (e.g., via an air pinch gesture directed to option 422b similar to the air pinch gesture 414a in FIG. 4A), the first electronic device 101a ceases to present the private user interface 416a and integrates the first user 410 as an active participant in the multi-user communication session. In some examples, integrating the first user 410 as an active participant in the multi-user communication session includes updating the spatial arrangement above to include the first user 410 of the first electronic device 101a (e.g., such that the location and/or orientation of the shared user interface 402a is also based on the location of the first user 410 in the physical environment) and permitting interaction with the shared user interface 402a as described in the figures that follow. In FIG. 4E, the first electronic device 101a optionally detects a selection of the option 422c (e.g., via an air pinch gesture directed to option 422c similar to the air pinch gesture 414a in FIG. 4A), which causes the first user 410 of the first electronic device 101a to remain an inactive participant in the multi-user communication session and the first electronic device 101a to maintain display of the private user interface 416a in the three-dimensional environment 400, as shown in FIG. 4F.

In some examples, when the first electronic device 101a determines that the private user interface 416a reaches a location in the three-dimensional environment 400 that is within a threshold distance of the shared user interface 402a, the first electronic device 101a performs a “snapping” operation for rejoining and/or adding the private user interface 416a back to the shared user interface 402a in the three-dimensional environment 400. In some examples, the “snapping” operation simulates (e.g., gives the appearance of) snapping the private user interface 416a to the shared user interface 402a and the private user interface 416a thereby disappearing (e.g., fading out, being merged with the shared user interface 402a, or otherwise ceasing to be displayed in the three-dimensional environment 400). This “snapping” operation optionally refers to the first electronic device 101a docking the detached private user interface 416a back into the shared user interface 402a.

In FIG. 4F, the first electronic device 101a detects a sequence of one or more inputs that includes an air pinch gesture 414f, optionally while attention 412f (e.g., gaze) of the first user 410 of the first electronic device 101a is directed to the grabber bar 416c of the private user interface 416a. In response to detecting this sequence of one or more inputs, the first electronic device 101a selects the private user interface 416a. In some examples, the first electronic device 101a detects that the sequence of one or more inputs includes movement of the air pinch gesture from a first location 414gg to a second location 414g in space, as shown in FIG. 4G. In response to detecting this sequence of one or more inputs, the first electronic device 101a moves the private user interface 416a in the three-dimensional environment 400 in accordance with the movement of the air pinch gesture, as shown in FIG. 4G. For example, as shown in the overhead view 408 in FIG. 4G, the first electronic device 101a moves the private user interface 416a from a first location 416aa within the three-dimensional environment 400 (e.g., corresponding to the second location within the three-dimensional environment 400 described above with reference to FIG. 4B) to a second location 416ab within the three-dimensional environment 400, while attention 412g (e.g., gaze) of the user of the electronic device 101 is directed to the grabber bar 416c of the private user interface 416a. In some examples, at this second location, the first electronic device 101a determines that the private user interface 416a is within a threshold distance (0.01, 0.1, 0.2, 0.5, 1, 2, 3, 5, or 10 meters) of the shared user interface 402a in the three-dimensional environment 400. In some examples, in response to the determination that the private user interface 416a is within the threshold distance of the shared user interface 402a (e.g., and in response to detecting termination of (e.g., a release of) the air pinch gesture provided by the hand of the first user 410), the first electronic device 101a automatically moves the private user interface 416a to a respective location corresponding to the shared user interface 402a, without detecting input for moving the private user interface 416a to the respective location corresponding to the shared user interface 402a (e.g., the first electronic device 101a performs the “snapping” operation described above). In some examples, automatically moving the private user interface 416a to the respective location corresponding to the shared user interface 402a includes ceasing presentation of the private user interface 416a within the three-dimensional environment 400, as shown in FIG. 4H. Additionally or alternatively, the shared user interface 402a is associated with a respective drop zone 402e, as shown in overhead view 408 in FIG. 4G (or, optionally referred to as a snap volume). In some examples, the drop zone 402e is an area of the three-dimensional environment 400 responsive to removing or ceasing the display of the private user interface 416a. For example, when the first electronic device 101a determines that the private user interface 416a is within respective drop zone 402e, as shown by the overhead view 408 in FIG. 4G, the first electronic device 101a ceases to present the private user interface 416a, as shown in FIG. 4H. In some examples, the drop zone 402e is based on (e.g., is calculated according to) the threshold distance discussed above relative to the shared user interface 402a.

In some examples, ceasing to present the private user interface 416a includes integrating the first user 410 as an active participant in the multi-user communication session. In some examples, integrating the first user 410 as an active participant in the multi-user communication session includes permitting interaction with the shared user interface 402a by the first user 410. For example, in FIG. 4H, after ceasing presentation of the private user interface 416a in the three-dimensional environment 400, the first electronic device 101a detects one or more selection inputs that include an air pinch gesture 414h while attention 412h (e.g., gaze) of the first user 410 of the first electronic device 101a is directed to a play option 424 of the shared user interface 402a. In some examples, as similarly described above, in response to detecting the one or more selection inputs, the first electronic device 101a causes the media content item to play in the shared user interface 402a. Thus, in some examples, interactions with the shared user interface 402a by the first user 410 are restored/enabled (e.g., no longer disabled) when the first user 410 is integrated as an active participant in the multi-user communication session.

In some examples, users in the multi-user communication session are informed about events or experiences within their shared group, such as when a private virtual object associated with a shared virtual object is included and/or generated in the multi-user communication session. For example, FIG. 4I illustrates the perspective of the second user 406 of the second electronic device 101b while the first user 410 of the first electronic device 101a is interacting with the private user interface 416a (e.g., after the first electronic device 101a generates the private user interface 416a as discussed above). In FIGS. 4I-4L, the overhead view 408 shows a different location of the first user 410 of the first electronic device 101a from the respective location of the first user 410 of the first electronic device 101 in FIGS. 4A-4L for illustrative clarity; however, it is understood that the same or similar characteristics, relationships to the other users/electronic devices, interactions with virtual objects, and descriptions described above with reference to FIGS. 4A-4L apply.

In FIG. 4I, the second electronic device 101b is displaying, via the display 120b, the shared user interface 402a including the grabber bar 402c and the close button 402d. The shared user interface 402a optionally also includes an option 440 that, when selected, causes the second electronic device 101b to pause playback of the media content item displayed by the shared user interface 402a, as similarly discussed above. In FIG. 4I, the second electronic device detects one or more selection inputs that include an air pinch gesture 428 (e.g., provided by a hand of the second user 406), optionally while attention 430a (e.g., gaze) of the second user 406 of the second electronic device 101b is directed to the option 440 of the shared user interface 402a. In some examples, in response to and/or while detecting the one or more selection inputs, as shown in FIG. 4I, the second electronic device 101b pauses playback of the media content item. In some examples, pausing playback of the media content item causes the second electronic device 101b to display, via the display 120b, a notification that all user interfaces associated with the shared user interface 402a are also paused, such as private user interface 416a. Although the examples described herein relate to playing or pausing playback of the media content item, it is understood that other changes to the shared user interface 402a (e.g., changes to the content of the shared user interface 402a) will cause an associated or corresponding (e.g., same) change to the private user interface 416a. Changes optionally include adding annotations to the content displayed by the shared user interface 402a, changing a visual appearance of the shared user interface 402a (e.g., light mode vs dark mode), zooming in/zooming out on content displayed by the shared user interface 402a, or other change.

In some examples, the second electronic device 101b presents a representation of the private user interface 416a that has been generated by and/or is being presented by the first electronic device 101a. Particularly, in some examples, the second electronic device 101b is configured to present a representation of the private user interface 416a in response to detecting attention of the second electronic device 101b directed toward or near the first user 410 of the first electronic device 101a. In FIG. 4J, the second electronic device 101b has detected a rotation of the head of the second user 406, as illustrated in the overhead view 408, which causes the field of view of the second user 406 of the second electronic device 101b to update to include a region of the three-dimensional environment 400b that includes the first user 410 of the first electronic device 101a. In some examples, at this field of view of the second user 406 of the second electronic device 101b, the physical persona of the first user 410 of the first electronic device 101a is visible. Additionally, in FIG. 4J, the second electronic device 101b detects attention 430a of the second user 406is directed to the region of the three-dimensional environment 400b that includes the first user 410 of the first electronic device 101a, as shown by a center line of attention 430b in the overhead view 408 of FIG. 4J. In some examples, in response to detecting the attention 430a of the second user 406 directed toward and/or near the physical persona of the first user 410 of the first electronic device 101a, the second electronic device 101b displays, via the display 120b, a notification 432 indicating that the first user 410 of the first electronic device 101 is an inactive participant in the multi-user communication session (e.g., described in more detail above) and a representation of the private user interface 416a that is being viewed by the first user 410 of the first electronic device 101a.

In some examples, the representation of the private user interface 416a is a type of virtual object (e.g., “phantom” virtual object) that is specifically displayed in the three-dimensional environment 400b in response to detecting attention directed to the region of the three-dimensional environment 400b that includes the first user 410 of the first electronic device 101a. In some examples, the representation of the private user interface 416a is not interactable with by the second user 406 of the second electronic device 101b or any user in the multi-user communication session other than the first user 410 of the first electronic device 101a. In some examples, the content of the private user interface 416a is not viewable by (e.g., is not visible to) the second user 406 of the second electronic device 101b or any user other than the first user 410 of the first electronic device 101a. Thus, in some examples, the second electronic device 101b displays the representation of the private user interface 416a with a blurred, darkened, or otherwise masked visual appearance, such that contents of the private user interface 416a are not visible to the second user 406 of the second electronic device 101b or any user other than the first user 410 of the first electronic device 101a in the multi-user communication session. In some examples, one or more interactions between the first user 410 of the first electronic device 101a and the private user interface 416a are visible to the second user 406 of the second electronic device 101b. For example, in response to the second electronic device 101b detecting an indication of movement of the private user interface 416a (e.g., the first user 410 of the first electronic device 101a provides input to move the private user interface 416a as similarly described with reference to FIG. 4B), the second electronic device 101b moves the representation of the private user interface 416a in accordance with the indication of the movement of the private user interface 416a and/or updates the location at which the representation of the private user interface 416a is displayed relative to the viewpoint of the second user 406 of the second electronic device 101b.

In some examples, when the second electronic device 101b detects the attention of the user directed away from the region of the three-dimensional environment 400b that includes the first user 410 of the first electronic device 101, such as attention 430c directed to the shared user interface 402a as shown in FIG. 4K including overhead view 408, the second electronic device 101b ceases or forgoes displaying the representation of the private user interface 416a, as shown in FIG. 4K. In some examples, although the second electronic device 101b ceases displaying the representation of the private user interface 416a, the private user interface 416a is active (e.g., being presented to the first user 410 of the first electronic device 101a) as indicated by the display of notification 432. In some examples, notification 432 is displayed because the first user 410 of the first electronic device is in the field of view of the second user 406 of the second electronic device 101b. In some examples, the electronic device 101b ceases to display the notification after a threshold amount of time (e.g., 0.5, 1, 2, 5, 10, 20, or 30 minutes) has elapsed.

In some examples, the second electronic device 101b detects an indication of the first electronic device 101a docking the private user interface 416a to the shared user interface 402a (e.g., ceasing display of the private user interface 416a in the three-dimensional environment 400b presented at the first electronic device 101a), as described in more detail previously with reference to FIG. 4G. In some examples, in response to detecting this indication, the second electronic device 101b displays, via the display 120b, a notification 442, as shown in FIG. 4L, indicating that the first user 410 of the first electronic device 101a is an active participant in the multi-user communication session (e.g., as a result of docking the private user interface 416a to the shared user interface 402a, as previously discussed above). In some examples, when the first user 410 of the first electronic device 101a is (and/or becomes) an active participant in the multi-user communication session (e.g., the first electronic device 101a is no longer displaying the private user interface 416a), and in accordance with a determination that the attention of the second user 406 of the second electronic device 101b is directed to the region of the three-dimensional environment 400b that includes the first user 410 of the first electronic device 101, the second electronic device 101b forgoes displaying the representation of the private user interface 416a, as similarly shown in FIG. 4K.

It is understood that the examples shown and described herein are merely exemplary and that additional and/or alternative elements may be provided within the three-dimensional environment for presenting private user interfaces associated with shared user interfaces. It should be understood that the appearance, shape, form, and size of each of the various user interface elements and objects shown and described herein are exemplary and that alternative appearances, shapes, forms and/or sizes may be provided. For example, the virtual objects representative of media content player user interface interfaces (e.g., shared user interface 402a and private user interface 416a) may be provided in alternative shapes than those shown, such as a rectangular shape, circular shape, triangular shape, etc. In some examples, the various selectable affordances (e.g., grabber bar 402c/416c, close button 402d/416d, option 426b, option 422c, option 424, and/or option 440) described herein may be selected verbally via user verbal commands (e.g., “select option” or “select virtual object” or “move user interface” verbal command). Additionally or alternatively, in some examples, the various options, user interface elements, control elements, etc. described herein may be selected and/or manipulated via user input received via one or more input devices in communication with the electronic device (or electronic devices). For example, selection input may be received via physical input devices, such as a mouse, trackpad, keyboard, etc. in communication with the electronic devices (or electronic devices), or a physical button integrated with the electronic devices (or electronic devices).

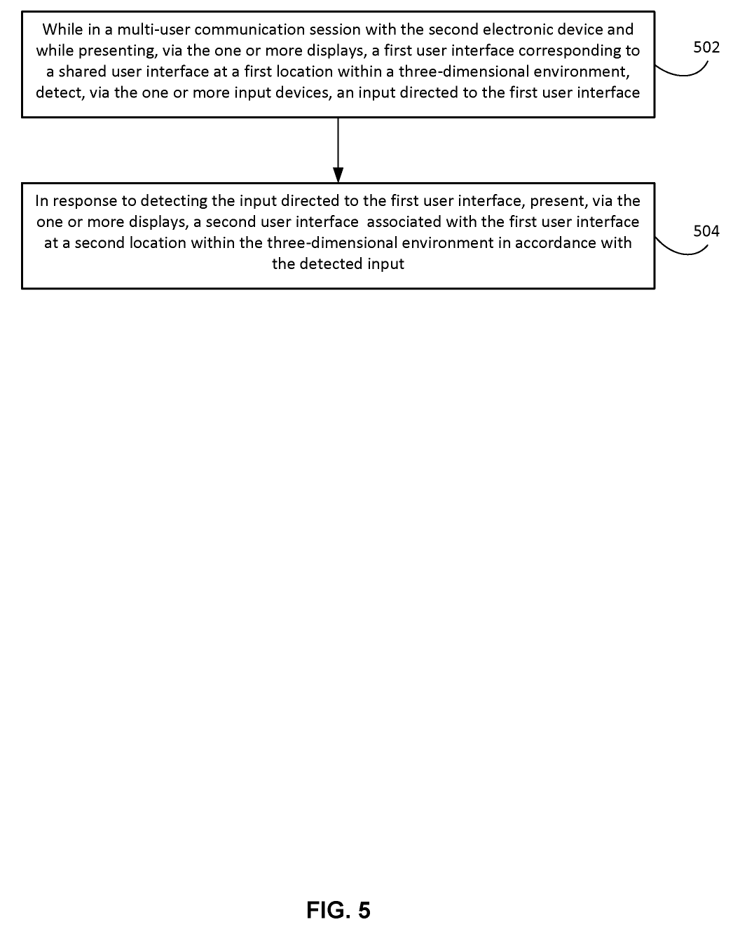

FIG. 5 illustrates a flow diagram illustrating an example process for presenting a user interface associated with a shared user interface in a multi-user communication session according to some examples of the disclosure. In some examples, process 500 begins at a first electronic device in communication with one or more displays and one or more input devices, wherein the first electronic device is collocated with a second electronic device in a physical environment. In some examples, the first electronic device is optionally a head-mounted display similar or corresponding to electronic device 201 of FIG. 2A or a mobile electronic device similar or corresponding to electronic device 260 of FIG. 2B. As shown in FIG. 5, in some examples, at 502, while in a multi-user communication session with the second electronic device and while presenting, via the one or more displays, a first user interface corresponding to a shared user interface at a first location within a three-dimensional environment, the first electronic device detects, via the one or more input devices, an input directed to the first user interface. For example, while the first electronic device (e.g., first electronic device 101a in FIG. 4A) is in a multi-user communication session with the second electronic device (e.g., second electronic device 101b in FIG. 4B), and while the first electronic device presents the first user interface (e.g., shared user interface 402a in FIG. 4B), the first electronic device detects the input directed to the first user interface (e.g., the sequence of one or more inputs directed to the shared user interface 402a including movement of the air pinch gesture from a first location 414b to a second location 414bb in FIG. 4B). In some examples, at 504, in response to detecting the input directed to the first user interface, the first electronic device presents, via the one or more displays, a second user interface associated with the first user interface at a second location within the three-dimensional environment in accordance with the detected input. For example, as shown in FIG. 4B, the first electronic device 101a presents private user interface 416a associated with the shared user interface 402a at a location within the three-dimensional environment 400.

It is understood that process 500 is an example and that more, fewer, or different operations can be performed in the same or in a different order. Additionally, the operations in process 500 described above are, optionally, implemented by running one or more functional modules in an information processing apparatus such as general-purpose processors (e.g., as described with respect to FIGS. 2A-2C) or application specific chips, and/or by other components of FIGS. 2A-2C.

Therefore, according to the above, some examples of the disclosure are directed to a method, wherein while the first user interface is presented at the first location within the three-dimensional environment, the first user interface is docked in the three-dimensional environment; and the input directed to the first user interface corresponds to a request to undock the first user interface from the first location within the three-dimensional environment. Additionally or alternatively, in some examples, the second user interface is a virtual instance of the first user interface. Additionally or alternatively, in some examples, while presenting the second user interface at the second location within the three-dimensional environment, the first electronic device detects, via the one or more input devices, a second input directed to the first user interface; and in response to detecting the second input directed to the first user interface, forgoes performing an action directed to the first user interface in accordance with the second input. Additionally or alternatively, in response to detecting the second input directed to the first user interface, the first electronic device presents, via the one or more displays, an indication that interactions with the first user interface are disabled within the three-dimensional environment. Additionally or alternatively, in some examples, while presenting the second user interface at the second location within the three-dimensional environment, the first electronic device detects, via the one or more input devices, a third input corresponding to a request to move the second user interface from the second location to a third location within the three-dimensional environment; in response to detecting the third input directed to the second user interface, the first electronic device moves the second user interface to the third location in accordance with the third input; while presenting the second user interface at the third location within the three-dimensional environment, the first electronic device detects a fourth input directed to the first user interface; and in response to detecting the fourth input: in accordance with a determination that the third location satisfies one or more criteria, the first electronic device performs one or more operations directed to the first user interface in accordance with the fourth input; and in accordance with a determination that the third location does not satisfy the one or more criteria, the first electronic device presents the indication that interactions with the first user interface are disabled within the three-dimensional environment.

Additionally or alternatively, in some examples, while presenting the second user interface at the second location within the three-dimensional environment, the first electronic device presents, via the one or more input devices, an event associated with the first user interface; and in response to detecting the event associated with the first user interface, the first electronic device changes a visual appearance of the second user interface in accordance with the event. Additionally or alternatively, in some examples, prior to detecting the input directed to the first user interface, the first electronic device and the second electronic device have a first spatial arrangement relative to the first user interface that is based on a first viewpoint of the first electronic device and a second viewpoint of the second electronic device in the three-dimensional environment, the method further comprising: while presenting the second user interface at the second location within the three-dimensional environment, the first electronic device detects, via the one or more input devices, an event that causes the first spatial arrangement of the first electronic device and the second electronic device to change; and in response to detecting the event, the first electronic device moves the first user interface from the first location to a third location within the three-dimensional environment that is based on the second viewpoint of the second electronic device and not the first viewpoint of the first electronic device. Additionally or alternatively, in some examples, presenting the second user interface at the second location within the three-dimensional environment causes a user of the first electronic device to become an inactive participant in the multi-user communication session relative to the first user interface, the method further comprising: while moving the first user interface from the first location to the third location within the three-dimensional environment that is based on the second viewpoint of the second electronic device, the first electronic device presents, via the one or more displays, a notification that is selectable to initiate a process for causing the user of the first electronic device to become an active participant in the multi-user communication session relative to the first user interface in the three-dimensional environment. Additionally or alternatively, in some examples, while presenting the notification, the first electronic device detects, via the one or more input devices, a second input directed to the notification and in response to detecting the second input directed to the notification, the first electronic device ceases to display the second user interface.

Additionally or alternatively, in some examples, while presenting the second user interface at the second location within the three-dimensional environment, the first electronic device detects, via the one or more input devices, a second input corresponding to a request to move the second user interface from the second location to a third location within the three-dimensional environment; and in response to detecting the second input corresponding to the request to move the second user interface from the second location to the third location within the three-dimensional environment, in accordance with a determination that the third location satisfies one or more criteria: the first electronic device ceases presentation of the second user interface within the three-dimensional environment. Additionally or alternatively, in some examples, the first electronic device and the second electronic device each includes a head-mounted display.

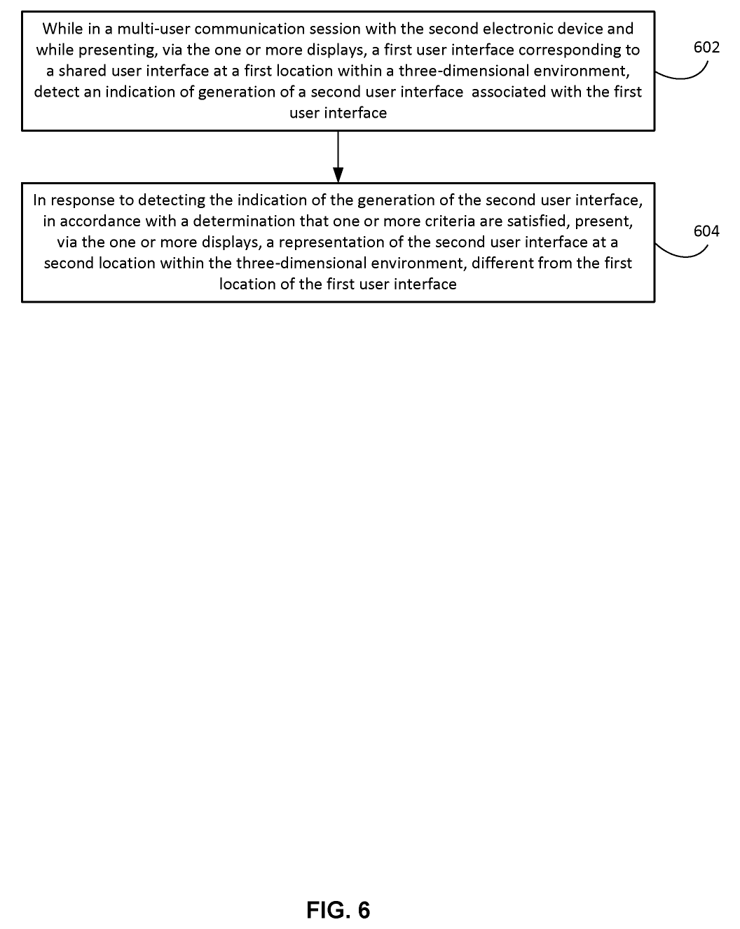

FIG. 6 illustrates a flow diagram illustrating an example process for presenting a representation of a user interface associated with a shared user interface in a multi-user communication session according to some examples of the disclosure. In some examples, process 600 begins at a first electronic device in communication with one or more displays and one or more input devices, wherein the first electronic device is collocated with a second electronic device in a physical environment. In some examples, the first electronic device is optionally a head-mounted display similar or corresponding to electronic device 201 of FIG. 2A or a mobile electronic device similar or corresponding to electronic device 260 of FIG. 2B. As shown in FIG. 6, in some examples, at 602, while in a multi-user communication session with the second electronic device and while presenting, via the one or more displays, a first user interface corresponding to a shared user interface at a first location within a three-dimensional environment, the first electronic device detects an indication of generation of a second user interface associated with the first user interface. For example, while the first electronic device (e.g., second electronic device 101b in FIGS. 4B and 4I) is in a multi-user communication session with the second electronic device (e.g., first electronic device 101a in FIGS. 4B and 4I), and while the first electronic device presents the first user interface (e.g., shared user interface 402a in FIG. 4I), the first electronic device detects the input directed to the first user interface (e.g., the sequence of one or more inputs from the first user 410 of the first electronic device 101a directed to the shared user interface 402a including movement of the air pinch gesture from a first location 414b to a second location 414bb in FIG. 4B). In some examples, at 604, in response to detecting the indication of the generation of the second user interface, in accordance with a determination that one or more criteria are satisfied, the first electronic device presents, via the one or more displays, a representation of the second user interface at a second location within the three-dimensional environment, different from the first location of the first user interface. For example, as shown in FIG. 4J, the second electronic device 101b determines that the one or more criteria are satisfied when the attention 410b is directed to a region within the three-dimensional environment that includes the first user 410 of the first electronic device 101a, and in accordance with this determination, the second electronic device 101b presents a representation of the private user interface 416a associated with the shared user interface 402a at a location within the three-dimensional environment 400.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIGS. 2A-2C) or application specific chips, and/or by other components of FIGS. 2A-2C.

Therefore, according to the above, some examples of the disclosure are directed to a method, wherein the one or more criteria include a criterion that is satisfied when the first electronic device detects an attention of a first user of the first electronic device directed to a region of the three-dimensional environment that includes a representation of a second user of the second electronic device. Additionally or alternatively, in some examples, while the attention of the first user is directed to the region of the three-dimensional environment that includes the representation of the second user of the second electronic device and while presenting the representation of the second user interface at the second location within the three-dimensional environment, the first electronic device detects an indication of movement of the second user interface; and in response to detecting the indication of movement of the second user interface, the first electronic device moves the representation of the second user interface from the second location to a third location within the three-dimensional environment in accordance with the indication of the movement of the second user interface. Additionally or alternatively, in some examples, presenting the first user interface includes presenting content of the first user interface with a first visual appearance that enables the content of the first user interface to be visible from a viewpoint of the first electronic device in the three-dimensional environment; and presenting the representation of the second user interface includes presenting content of the second user interface with a second visual appearance, different from the first visual appearance, that does not enable the content of the second user interface to be visible from the viewpoint of the first electronic device in the three-dimensional environment. Additionally or alternatively, in some examples, while the first user interface is presented at the first location within the three-dimensional environment, the first user interface is docked in the three-dimensional environment; and detecting the indication of generation of the second user interface associated with the first user interface includes detecting an indication of input detected by the second electronic device corresponding to undocking of the first user interface from the first location within the three-dimensional environment. Additionally or alternatively, in some examples, the second user interface is a virtual instance of the first user interface. Additionally or alternatively, in some examples, while presenting the representation of the second user interface, the first electronic device detects, via the one or more input devices, one or more inputs corresponding to a request to change the first user interface; and in response to detecting the one or more inputs corresponding to the request to change the first user interface, transmitting an indication that the change to the first user interface causes an associated change to the second user interface.

Additionally or alternatively, in some examples, prior to presenting the second user interface, the first electronic device and the second electronic device have a first spatial arrangement relative to the first user interface that is based on a first viewpoint of the first electronic device and a second viewpoint of the second electronic device in the three-dimensional environment, the method further comprising: while presenting the representation of the second user interface at the second location within the three-dimensional environment, detecting, via the one or more input devices, movement of the second viewpoint of the second electronic device; and in response to detecting the movement of the second viewpoint of the second electronic device, maintaining presentation of the first user interface at the first location. Additionally or alternatively, in some examples, the generation of the second user interface within the three-dimensional environment causes a second user of the second electronic device to become an inactive participant in the multi-user communication session relative to the first user interface, the method further comprising: while presenting the representation of the second user interface at the second location within the three-dimensional environment, detecting, via the one or more input devices, an indication of input detected by the second electronic device corresponding to docking the second user interface to the first location of the first user interface; and in response to detecting the indication of input detected by the second electronic device corresponding to docking the second user interface to the first location of the first user interface, presenting, via the one or more displays, a notification that the second user of the second electronic device is an active participant in the multi-user communication session relative to the first user interface in the three-dimensional environment. Additionally or alternatively, in some examples, while presenting the notification that the second user of the second electronic device is an active participant in the multi-user communication session, detecting, via the one or more input devices, an attention of a first user of the first electronic device directed to a region of the three-dimensional environment that includes a representation of the second user of the second electronic device; and in response to detecting the attention of the first user of the first electronic device directed to the region of the three-dimensional environment that includes the representation of the second user of the second electronic device, forgoing presentation of the representation of the second electronic device. Additionally or alternatively, in some examples, the first electronic device and the second electronic device each includes a head-mounted display.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some examples, the data utilized can include personal information data that uniquely identifies or can be used to contact or locate a specific person. Such personal information data can include demographic data, content consumption activity, location-based data, telephone numbers, email addresses, twitter ID's, home addresses, data or records relating to a user’s health or level of fitness (e.g., vital signs measurements, medication information, exercise information), date of birth, or any other identifying or personal information. Specifically, as described herein, one aspect of the present disclosure is tracking a user’s location data and gaze data.

The present disclosure recognizes that the use of such personal information data, in the present technology, can be used to the benefit of users. For example, personal information data can be used to display suggested text (e.g., within notifications) that changes based on changes in a user’s biometric data. For example, the suggested text is updated based on changes to the user’s gaze data (e.g., suggesting that the user close the private user interface 416a in FIG. 4B in response to detecting the user’s gaze directed away from the private user interface).

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user can be notified upon initiating collection that their personal information data will be accessed and then reminded again just before personal information data is accessed by the one or more devices.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative descriptions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more displays and one or more input devices, wherein the first electronic device is collocated with a second electronic device in a physical environment:
while in a multi-user communication session with the second electronic device and while presenting, via the one or more displays, a first user interface corresponding to a shared user interface at a first location within a three-dimensional environment, detecting, via the one or more input devices, an input directed to the first user interface; and
in response to detecting the input directed to the first user interface, presenting, via the one or more displays, a second user interface associated with the first user interface at a second location within the three-dimensional environment in accordance with the detected input.

2. The method of claim 1, further comprising:
while presenting the second user interface at the second location within the three-dimensional environment, detecting, via the one or more input devices, a second input directed to the first user interface; and
in response to detecting the second input directed to the first user interface:
forgoing performing an action directed to the first user interface in accordance with the second input; or
presenting, via the one or more displays, an indication that interactions with the first user interface are disabled within the three-dimensional environment.

3. The method of claim 2, further comprising:
while presenting the second user interface at the second location within the three-dimensional environment, detecting, via the one or more input devices, a third input corresponding to a request to move the second user interface from the second location to a third location within the three-dimensional environment;
in response to detecting the third input directed to the second user interface, moving the second user interface to the third location in accordance with the third input;
while presenting the second user interface at the third location within the three-dimensional environment, detecting a fourth input directed to the first user interface; and
in response to detecting the fourth input:
in accordance with a determination that the third location satisfies one or more criteria, performing one or more operations directed to the first user interface in accordance with the fourth input; and
in accordance with a determination that the third location does not satisfy the one or more criteria, presenting the indication that interactions with the first user interface are disabled within the three-dimensional environment.

4. The method of claim 1, further comprising:
while presenting the second user interface at the second location within the three-dimensional environment, detecting, via the one or more input devices, an event associated with the first user interface; and
in response to detecting the event associated with the first user interface, changing a visual appearance of the second user interface in accordance with the event.

5. The method of claim 1, wherein, prior to detecting the input directed to the first user interface, the first electronic device and the second electronic device have a first spatial arrangement relative to the first user interface that is based on a first viewpoint of the first electronic device and a second viewpoint of the second electronic device in the three-dimensional environment, the method further comprising:
while presenting the second user interface at the second location within the three-dimensional environment, detecting, via the one or more input devices, an event that causes the first spatial arrangement of the first electronic device and the second electronic device to change; and
in response to detecting the event, moving the first user interface from the first location to a third location within the three-dimensional environment that is based on the second viewpoint of the second electronic device and not the first viewpoint of the first electronic device.

6. The method of claim 5, wherein presenting the second user interface at the second location within the three-dimensional environment causes a user of the first electronic device to become an inactive participant in the multi-user communication session relative to the first user interface, the method further comprising:
while moving the first user interface from the first location to the third location within the three-dimensional environment that is based on the second viewpoint of the second electronic device, presenting, via the one or more displays, a notification that is selectable to:
initiate a process for causing the user of the first electronic device to become an active participant in the multi-user communication session relative to the first user interface in the three-dimensional environment; or
cease to display the second user interface.

7. The method of claim 1, further comprising:
while presenting the second user interface at the second location within the three-dimensional environment, detecting, via the one or more input devices, a second input corresponding to a request to move the second user interface from the second location to a third location within the three-dimensional environment; and
in response to detecting the second input corresponding to the request to move the second user interface from the second location to the third location within the three-dimensional environment, in accordance with a determination that the third location satisfies one or more criteria:
ceasing presentation of the second user interface within the three-dimensional environment.

8. The method of claim 1, wherein:
while the first user interface is presented at the first location within the three-dimensional environment, the first user interface is docked in the three-dimensional environment;
the input directed to the first user interface corresponds to a request to undock the first user interface from the first location within the three-dimensional environment; or
the second user interface is a virtual instance of the first user interface.

9. A first electronic device, comprising:
one or more processors;
memory; and
one or more programs stored in the memory and configured to be executed by the one or more processors, the one or more programs including instructions for performing a method, comprising:
while in a multi-user communication session with a second electronic device, wherein the first electronic device is collocated with the second electronic device in a physical environment, and while presenting, via one or more displays, a first user interface corresponding to a shared user interface at a first location within a three-dimensional environment, detecting, via one or more input devices, an input directed to the first user interface; and
in response to detecting the input directed to the first user interface, presenting, via the one or more displays, a second user interface associated with the first user interface at a second location within the three-dimensional environment in accordance with the detected input.

10. The first electronic device of claim 9, the method further comprising:
while presenting the second user interface at the second location within the three-dimensional environment, detecting, via the one or more input devices, a second input directed to the first user interface; and
in response to detecting the second input directed to the first user interface:
forgoing performing an action directed to the first user interface in accordance with the second input; or
presenting, via the one or more displays, an indication that interactions with the first user interface are disabled within the three-dimensional environment.

11. The first electronic device of claim 10, the method further comprising:
while presenting the second user interface at the second location within the three-dimensional environment, detecting, via the one or more input devices, a third input corresponding to a request to move the second user interface from the second location to a third location within the three-dimensional environment;
in response to detecting the third input directed to the second user interface, moving the second user interface to the third location in accordance with the third input;
while presenting the second user interface at the third location within the three-dimensional environment, detecting a fourth input directed to the first user interface; and
in response to detecting the fourth input:
in accordance with a determination that the third location satisfies one or more criteria, performing one or more operations directed to the first user interface in accordance with the fourth input; and
in accordance with a determination that the third location does not satisfy the one or more criteria, presenting the indication that interactions with the first user interface are disabled within the three-dimensional environment.

12. The first electronic device of claim 9, the method further comprising:
while presenting the second user interface at the second location within the three-dimensional environment, detecting, via the one or more input devices, an event associated with the first user interface; and
in response to detecting the event associated with the first user interface, changing a visual appearance of the second user interface in accordance with the event.

13. The first electronic device of claim 9, wherein, prior to detecting the input directed to the first user interface, the first electronic device and the second electronic device have a first spatial arrangement relative to the first user interface that is based on a first viewpoint of the first electronic device and a second viewpoint of the second electronic device in the three-dimensional environment, the method further comprising:
while presenting the second user interface at the second location within the three-dimensional environment, detecting, via the one or more input devices, an event that causes the first spatial arrangement of the first electronic device and the second electronic device to change; and
in response to detecting the event, moving the first user interface from the first location to a third location within the three-dimensional environment that is based on the second viewpoint of the second electronic device and not the first viewpoint of the first electronic device.

14. The first electronic device of claim 13, wherein presenting the second user interface at the second location within the three-dimensional environment causes a user of the first electronic device to become an inactive participant in the multi-user communication session relative to the first user interface, the method further comprising:
while moving the first user interface from the first location to the third location within the three-dimensional environment that is based on the second viewpoint of the second electronic device, presenting, via the one or more displays, a notification that is selectable to:
initiate a process for causing the user of the first electronic device to become an active participant in the multi-user communication session relative to the first user interface in the three-dimensional environment; or
cease to display the second user interface.

15. The first electronic device of claim 9, the method further comprising:
while presenting the second user interface at the second location within the three-dimensional environment, detecting, via the one or more input devices, a second input corresponding to a request to move the second user interface from the second location to a third location within the three-dimensional environment; and
in response to detecting the second input corresponding to the request to move the second user interface from the second location to the third location within the three-dimensional environment, in accordance with a determination that the third location satisfies one or more criteria:
ceasing presentation of the second user interface within the three-dimensional environment.

16. The first electronic device of claim 9, the method further comprising:
while the first user interface is presented at the first location within the three-dimensional environment, the first user interface is docked in the three-dimensional environment;
the input directed to the first user interface corresponds to a request to undock the first user interface from the first location within the three-dimensional environment; or
the second user interface is a virtual instance of the first user interface.

17. A non-transitory computer readable storage medium storing one or more programs, the one or more programs comprising instructions, which when executed by one or more processors of a first electronic device, cause the first electronic device to perform a method, comprising:
while in a multi-user communication session with a second electronic device, wherein the first electronic device is collocated with the second electronic device in a physical environment, and while presenting, via one or more displays, a first user interface corresponding to a shared user interface at a first location within a three-dimensional environment, detecting, via one or more input devices, an input directed to the first user interface; and
in response to detecting the input directed to the first user interface, presenting, via the one or more displays, a second user interface associated with the first user interface at a second location within the three-dimensional environment in accordance with the detected input.

18. The non-transitory computer readable storage medium of claim 17, the method further comprising:
while presenting the second user interface at the second location within the three-dimensional environment, detecting, via the one or more input devices, a second input directed to the first user interface; and
in response to detecting the second input directed to the first user interface:
forgoing performing an action directed to the first user interface in accordance with the second input; or
presenting, via the one or more displays, an indication that interactions with the first user interface are disabled within the three-dimensional environment.

19. The non-transitory computer readable storage medium of claim 18, the method further comprising:
while presenting the second user interface at the second location within the three-dimensional environment, detecting, via the one or more input devices, a third input corresponding to a request to move the second user interface from the second location to a third location within the three-dimensional environment;
in response to detecting the third input directed to the second user interface, moving the second user interface to the third location in accordance with the third input;
while presenting the second user interface at the third location within the three-dimensional environment, detecting a fourth input directed to the first user interface; and
in response to detecting the fourth input:
in accordance with a determination that the third location satisfies one or more criteria, performing one or more operations directed to the first user interface in accordance with the fourth input; and
in accordance with a determination that the third location does not satisfy the one or more criteria, presenting the indication that interactions with the first user interface are disabled within the three-dimensional environment.

20. The non-transitory computer readable storage medium of claim 17, the method further comprising:
while presenting the second user interface at the second location within the three-dimensional environment, detecting, via the one or more input devices, an event associated with the first user interface; and
in response to detecting the event associated with the first user interface, changing a visual appearance of the second user interface in accordance with the event.

21. The non-transitory computer readable storage medium of claim 17, wherein, prior to detecting the input directed to the first user interface, the first electronic device and the second electronic device have a first spatial arrangement relative to the first user interface that is based on a first viewpoint of the first electronic device and a second viewpoint of the second electronic device in the three-dimensional environment, the method further comprising:
while presenting the second user interface at the second location within the three-dimensional environment, detecting, via the one or more input devices, an event that causes the first spatial arrangement of the first electronic device and the second electronic device to change; and
in response to detecting the event, moving the first user interface from the first location to a third location within the three-dimensional environment that is based on the second viewpoint of the second electronic device and not the first viewpoint of the first electronic device.

22. The non-transitory computer readable storage medium of claim 21, wherein presenting the second user interface at the second location within the three-dimensional environment causes a user of the first electronic device to become an inactive participant in the multi-user communication session relative to the first user interface, the method further comprising:
while moving the first user interface from the first location to the third location within the three-dimensional environment that is based on the second viewpoint of the second electronic device, presenting, via the one or more displays, a notification that is selectable to:
initiate a process for causing the user of the first electronic device to become an active participant in the multi-user communication session relative to the first user interface in the three-dimensional environment; or
cease to display the second user interface.

23. The non-transitory computer readable storage medium of claim 17, the method further comprising:
while presenting the second user interface at the second location within the three-dimensional environment, detecting, via the one or more input devices, a second input corresponding to a request to move the second user interface from the second location to a third location within the three-dimensional environment; and
in response to detecting the second input corresponding to the request to move the second user interface from the second location to the third location within the three-dimensional environment, in accordance with a determination that the third location satisfies one or more criteria:
ceasing presentation of the second user interface within the three-dimensional environment.

24. The non-transitory computer readable storage medium of claim 17, the method further comprising:
while the first user interface is presented at the first location within the three-dimensional environment, the first user interface is docked in the three-dimensional environment;
the input directed to the first user interface corresponds to a request to undock the first user interface from the first location within the three-dimensional environment; or
the second user interface is a virtual instance of the first user interface.
